(19) United States
(12) Patent Application Publication
(10) Pub. No.: US 2026/0126560 A1
(43) Pub. Date: May 7, 2026

(54) HORIZONTAL DIRECTIONAL DRILLING SONDE WITH ADVANCED MAGNETIC CORE TECHNOLOGY AND ASSOCIATED METHODS

(71) Applicant: Merlin Technology, Inc., Kent, WA (US)

(72) Inventors: Rudolf Zeller, Seattle, WA (US); Scott Phillips, Normandy Park, WA (US); Timothy Lang, Renton, WA (US); Jason Pothier, Auburn, WA (US); Joseph Tyler Zrebiec, North Bend, WA (US)

(21) Appl. No.: 18/939,276

(22) Filed: Nov. 6, 2024

(51) Int. Cl. G01V 3/12; E21B 7/04; E21B 47/13; G01V 3/28

(52) U.S. Cl. CPC G01V 3/12; E21B 47/13; G01V 3/28; E21B 7/046

(57) ABSTRACT

A transmitter is disclosed that includes an electromagnetically permeable ductile core formed from a flexible core material. An antenna coil is wound around the flexible electromagnetically permeable ductile core to surround at least one portion of the electronics region and another portion of the battery region. An elongated outer tube serves as an outer structural member of the transmitter that is sealable at first and second opposing ends. The core can be formed from a wrapped electromagnetically permeable sheet material such as silicon steel. An associated wrapping table and method are described.

### BACKGROUND

The present application is generally directed to the field of horizontal directional drilling and, more particularly, to an inground device or sonde and associated methods.

While not intended as being limiting, one example of an application which involves the use of an inground device or sonde (i.e., transmitter) is Horizontal Directional Drilling (HDD). The latter can be used for purposes of installing a utility without the need to dig a trench. A typical utility installation involves the use of a drill rig having a drill string that supports a boring tool, serving as one embodiment of an inground tool, at a distal or inground end of the drill string. The drill rig forces the boring tool through the ground by applying a thrust force to the drill string. The boring tool is steered during the extension of the drill string to form a pilot bore. Upon completion of the pilot bore, the distal end of the drill string is attached to a pullback apparatus which is, in turn, attached to a leading end of the utility. The pullback apparatus and utility are then pulled through the pilot bore via retraction of the drill string to complete the installation. In some cases, the pullback apparatus can comprise a back reaming tool, serving as another embodiment of an inground tool, which expands the diameter of the pilot bore ahead of the utility so that the installed utility can be of a greater diameter than the original diameter of the pilot bore.

Locating systems are commonly used in HDD to help ensure that the underground utility is installed along the desired path (including depth) underground. Walkover locating systems are the most common form of locating system, and typically include a battery-powered transmitter (or sonde) that is carried by a drill housing. The drill housing defines a cavity for receiving the transmitter proximate to the boring tool, and is configured to withstand the rigors of drilling to help protect the transmitter. The transmitter collects positional data underground and transmits this data wirelessly to the surface via a locating signal, with the locating signal being picked up by an above-ground receiver. With particularly long underground drilling projects, the battery life of the transmitter can become a limiting factor. Alternatively, particularly deep underground drilling projects, and/or drilling projects that encounter interference, can make it difficult for the above-ground receiver to pick up the locating signal from the transmitter, which in turn can interrupt the drilling project. One method to overcome these challenges is to transmit a stronger signal which can then be picked up by the above-ground receiver. However, transmitting a stronger signal typically involves consuming additional power from the battery. Increasing battery capacity can help extend the life of the battery to allow for longer drilling projects, or enable transmission of a stronger signal to enable locating in deep projects or environments with heavy interference.

HDD transmitters are generally designed to be as small as possible to allow for greater maneuverability underground. Accordingly, increasing battery capacity is not typically as simple as installing a larger battery into an existing HDD transmitter design since there typically is not excess space available inside these transmitters. One approach to accommodate a larger battery is to modify the design of the HDD transmitter to increase the diameter and/or length. However, increasing the size of the transmitter introduces challenges since this would also require a larger drill housing. The size of drill housings in the HDD industry have become standardized around industry standard HDD transmitters (by way of non-limiting example, 1.25″ outer diameter and either 12″ or 19″ long) to help keep the cost of these housings more affordable. Larger, custom designed drill housings are not readily available and would increase the costs of completing drilling projects in what is a highly cost-competitive industry.

In one prior art design, the batteries are received in a central cavity of the transmitter coaxially along with a dielectric antenna rod to transmit the locating signal as a dipole electromagnetic field. In such a design and given a fixed peripheral outline of the overall transmitter housing, increasing the battery length reduces the space available for the antenna rod and vice versa. In this regard, it should be appreciated that decreasing the length of the antenna rod generally results in reduced transmission efficiency, thereby demanding more battery power and potentially negating the benefit of a longer higher capacity battery.

A related approach seen in the prior art resides in forming an antenna core around a tubular support to form an axial cavity such that batteries can be received in the axial cavity. Examples of this approach can be seen in U.S. Pat. Nos. 8,674,894, 9,798,033 (hereinafter, the '033 patent), U.S. Pat. No. 10,246,990 (hereinafter, the '990 patent), U.S. Pat. Nos. 11,187,822 and 12.099,162. This approach can also provide for a relatively longer antenna while still providing improved battery compartment volume. Applicant submits that designs produced according to the subject patents appear to have a peripheral outline of increased diameter that is difficult to fit in an industry standard drill housing, particularly when the battery compartment accommodates standard sized batteries. One reason for this appears to be the various design approaches taken by the subject patents.

The '894 patent proposes metal (in particular, mu metal) magnetic core strips, and is critical of the use of ferrite materials. Mu metal is an alloy of nickel and iron. The patent admits that the use of metal is problematic due to the introduction of eddy current losses. The patent attempts to deal with this material driven concern by surrounding its metal strips with an insulating layer (see FIG. 3) since it is necessary to keep the metal strips electrically insulated from one another (see col. 3, lns. 4-15) to reduce eddy currents. These strips are held in a rather complex support structure 22 that is shown in FIG. 2. At col. 2, ln. 61, carrying over to col. 3, ln. 3, the patent suggests that the strips can be laminated to further reduce eddy currents for higher frequencies. While the '894 patent prefers strips with a rectangular cross-section (col. 2, lns. 52-53), the patent mentions that other shapes can be used (col. 2, lns. 58-60). Applicant submits that the use of such strips contributes to making the sidewall thickness of the transmitter housing relatively thicker based, for example, on the thickness of the material that forms the strips as well as the need for a support structure to retain the strips. Unfortunately, the use of strips in this patent may also come at the expense of manufacturability at least for the reason that the strips require a more complex overall structure.

The '990 patent, like the '894 patent, proposes the use of metal strips. In this case, the strips are elongated arcuate strips that are formed from nickel steel, which is admitted to be a somewhat rigid material to assertedly “meet the requirements of use” (see col. 5, lns. 2-4). Applicant assumes that this refers to the strips as being of relatively high strength. As noted above, a metal-based material such as nickel steel, like Mu metal, is subject to the problematic production of eddy currents. Thus, the '990 patent, like the '894 patent, uses strips as a solution to the problem of eddy currents. The strips of the '990 patent are rather complex in structure and are held in position by insulating spacers 111 that are shown in FIG. 4 and are themselves rather complex.

The '033, '822 and '162 patents primarily contemplate “core section elements” comprised of ferrite arc-shaped elements. Based on the plain language meaning of the term “core section elements”, it is clear that each element forms only one part or “section” of an overall core. There is no unitary core element shown in the patent drawings that comprises the entire core. In this regard, each of these patents explicitly states that “Since there are separate core section elements, they may be more resistant to impact or twisting breakage (as compared to a single tubular ferrite core) in sondes using this type of core structure” (see, for example, col. 11, lns. 19-57 of the '033 patent and col. 11, lns. 21-59 of the '822 patent). Accordingly, the use of core section elements in these patents is the result of a different material driven concern. In particular, the concern is the fragile nature of ferrite materials. Applicant submits that this approach will increase the complexity and thickness of the structure as well as manufacturing costs since the separate core section elements require support within an overall structure.

In view of deficiencies of the prior art recognized above by Applicant, it is submitted that there remains a need for improvement. The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one aspect of the disclosure, embodiments and associated methods are directed to a transmitter including an elongated inner tube defining at least a portion of an electronics region for receiving an electronics module and a battery region for receiving at least one battery. An electromagnetically permeable ductile core surrounds the elongated inner tube formed from a flexible core material. An antenna coil is wound around the flexible electromagnetically permeable ductile core to surround at least one portion of the electronics region and another portion of the battery region. An elongated outer tube serves as an outer structural member of the transmitter that is sealable at first and second opposing ends.

In one feature, the elongated inner tube, the electromagnetically permeable ductile core and the antenna coil are encapsulated for receiving the elongated outer tube.

In another feature, the elongated outer tube is bonded to the antenna coil and the electromagnetically permeable ductile core such that the antenna coil and the electromagnetically permeable ductile core are encapsulated between the elongated outer tube and the elongated inner tube as part of an integral unit.

In still another aspect of the disclosure, embodiments and associated methods are directed to a transmitter having an elongated housing defining an interior cavity including an electronics region receiving an electronics module and a battery compartment. A battery pack is receivable in the battery compartment for powering the electronics module. A battery end cap extractor is removably receivable on an end of the elongated housing proximate to the battery compartment configured to cooperate with the battery pack, when received in the battery compartment, such that removing the end cap assembly extracts the battery pack from the battery compartment.

In yet another aspect of the disclosure, embodiments and associated methods are directed to an end cap for a transmitter having an elongated transmitter body with an end opening for receiving the end cap and having an outer diameter include a main body defining an interior cavity. The main body includes an inward end configured as a tubular sleeve for sealed engagement with the elongated transmitter body and for surrounding a portion of the interior cavity. A peripheral sidewall configuration surrounds the interior cavity between the inward end and the outward end, the peripheral sidewall configuration defining an inset floor for supporting a radio frequency antenna and the inset floor includes a feedthrough leading to the interior cavity for routing an electrical conductor therethrough to electrically connect the radio frequency antenna to a radio frequency transceiver that forms part of an electronics module housed within the transmitter for external radio frequency communication.

In one non-limiting feature, an outward end defines a pressure port at an outer end of the interior cavity for receiving a pressure sensor to expose a pressure membrane of the pressure sensor to an ambient pressure surrounding the transmitter.

In still another aspect of the disclosure, embodiments and associated methods are directed to a transmitter including an elongated tubular transmitter body serving to define an electronics region for receiving an electronics module and a battery region for receiving a battery pack such that the elongated transmitter body is sealable by a first end cap and an opposing, second end cap. The first end cap including a main body that defines an interior cavity. The main body includes an inward end configured as a tubular sleeve for sealed engagement with the elongated transmitter body and surrounding a portion of the interior cavity. A peripheral sidewall configuration surrounds the interior cavity between the inward end and the outward end, the peripheral sidewall configuration defining an inset floor for supporting a radio frequency antenna and the inset floor including a feedthrough leading to the interior cavity for routing an electrical conductor therethrough to electrically connect the radio frequency antenna to a radio frequency transceiver that forms one part of an electronics module for external radio frequency communication.

In a continuing aspect of the disclosure, embodiments and associated methods are directed to a transmitter including an elongated tubular transmitter body serving to define an electronics region for receiving an electronics module including an end portion that supports a radio frequency transceiver having an antenna and a battery region for receiving a battery pack such that the elongated transmitter body is sealable by a first end cap and an opposing, second end cap. The first end cap includes a main body that defines an interior cavity. The main body includes an inward end configured as a tubular sleeve for sealed engagement with the elongated transmitter body and surrounding a portion of the interior cavity. An outward end of the main body defines a pressure sensor aperture at an outer end of the interior cavity for receiving a pressure sensor to expose a pressure membrane of the pressure sensor to an ambient pressure surrounding the transmitter. A peripheral sidewall configuration surrounds the interior cavity between the inward end and the outward end such that the end portion of the electronics module is received in the interior cavity to place the antenna of the radio frequency transmitter in a confronting relationship with a sealed window that is defined by the peripheral sidewall configuration for external radio frequency communication through the window.

In a further aspect of the disclosure, embodiments and associated methods are directed to an end cap for a transmitter used in an inground operation are described. The transmitter includes a transmitter body that defines an opening leading to a transmitter interior cavity which is configured to receive an electronics package and at least one battery. The end cap includes an end cap body including (i) an annular inner end configured for removably sealingly engaging the opening of the transmitter body such that the battery is removably installable in the transmitter interior cavity with the end cap removed from the transmitter body and (ii) an outer closed end, opposite the annular inner end, that defines an aperture for use in equalizing pressure in the transmitter interior cavity with an ambient environment. A thermal safety plug is sealingly received in the aperture having a predetermined failure temperature such that the transmitter interior cavity is pressure isolated from the ambient environment during operation of the transmitter which subjects the thermal safety plug to temperatures below the predetermined failure temperature and, above the predetermined failure temperature, the thermal safety plug releases an internal pressure of the transmitter interior cavity to the ambient environment.

In another aspect of the disclosure, embodiments and associated methods are directed to an apparatus for wrapping a flexible permeable magnetic sheet material onto a core tube to form a magnetic core include a first roller and a second roller supported for free rotation about a first elongation axis and second elongation axis, respectively, and in a spaced apart, parallel relationship. A driven roller is supported for selective rotation about a drive roller elongation axis, the driven roller selectively movable between an engaged position and a disengaged position such that, in the engaged position, the core tube is captured between the drive roller, the first roller and the second roller and, responsive to rotation of the driven roller, at least the flexible permeable magnetic sheet material (i) enters between the first roller and the core tube, (ii) is carried by the core tube for compression between the second roller and the core tube and (iii) carried by the core tube for further compression between the driven roller and the core tube to wrap the flexible permeable magnetic sheet material around the core tube and onto one or more underlying layers of the flexible permeable magnetic sheet material and, in the disengaged position, the core tube and the flexible permeable sheet material wrapped therearound are removable from the apparatus.

### BRIEF DESCRIPTIONS OF THE DRAWINGS

Example embodiments are illustrated in referenced figures of the drawings. It is intended that the embodiments and figures disclosed herein are to be illustrative rather than limiting.

FIG. 1 is a diagrammatic view, in perspective, of an embodiment of a transmitter produced in accordance with the present disclosure.

FIG. 2 is a diagrammatic view, in elevation, illustrating the transmitter of FIG. 1 adjacent to a drill housing for installation therein.

FIG. 3 is a diagrammatic view, in perspective, illustrating an initial step in the production of an embodiment of a ductile magnetic core in accordance with the present disclosure.

FIG. 4 is a diagrammatic view, in perspective, illustrating an inner tube arranged to receive a flexible permeable magnetic sheet material in a transmitter embodiment produced in accordance with the present disclosure.

FIG. 5 is a diagrammatic view, in perspective, shown here to illustrate an intermediate step in the formation of an embodiment of a ductile magnetic core in accordance with the present disclosure.

FIG. 6 is a diagrammatic view, in perspective, showing an intermediate assembly including the ductile magnetic core of FIG. 5 with an antenna coil or winding received thereon in accordance with the present disclosure.

FIG. 7 is a diagrammatic view, in perspective, illustrating an outer, main body tube arranged to slidingly receive the ductile magnetic core of FIG. 6 in accordance with an embodiment of the present disclosure.

FIG. 8 is a diagrammatic exploded view, in perspective, illustrating an embodiment of a battery end cap assembly that includes a battery end cap receptacle and removable battery end cap in accordance with the present disclosure.

FIG. 9 is a diagrammatic view, in perspective, of an embodiment of a centralizer which is used at one end of the transmitter opposite the end cap assembly of FIG. 8 in accordance with the present disclosure.

FIG. 10 is a diagrammatic view, in elevation, showing an embodiment of an intermediate assembly received in an embodiment of a clamping arrangement for performing an encapsulation process in accordance with the present disclosure.

FIG. 11 is a diagrammatic cut away partial view, in perspective, illustrating the appearance of the end of the intermediate assembly of FIG. 10 which receives the centralizer of FIG. 9 in accordance with the present disclosure.

FIG. 12 is a diagrammatic cut through and further enlarged view, in elevation, showing an embodiment of the structure of a sidewall of the intermediate assembly of FIG. 10 subsequent to encapsulation in accordance with the present disclosure.

FIG. 13 is a diagrammatic, partially exploded view of an embodiment of the transmitter of the present disclosure, shown here to illustrate further details with respect assembly.

FIGS. 14a and 14b are diagrammatic views of an embodiment of an end cap configured in accordance with the present disclosure to support external communications.

FIGS. 14c and 14d are diagrammatic views of another embodiment of an end cap configured to support external communications as well as a pressure sensor in accordance with the present disclosure.

FIG. 15 is a diagrammatic exploded view, in perspective, illustrating a relationship between the embodiment of the battery end cap assembly of FIG. 8 and additional components relating to a battery pack that is removably receivable within the embodiment of the encapsulated intermediate assembly shown in FIG. 13.

FIG. 16 is another diagrammatic exploded view, in perspective, shown here to illustrate additional details of the various components seen in FIG. 15 from a different perspective.

FIG. 17 is a diagrammatic view, in perspective, illustrating details of an embodiment of a battery extractor spacer in accordance with the present disclosure.

FIGS. 18a and 18b illustrate an additional embodiment of a battery extractor spacer in accordance with the present disclosure.

FIG. 19 is a diagrammatic view, in perspective, illustrating an embodiment of a manufacturing table, generally indicated by the reference number 700, which facilitates the process depicted by FIG. 4 for wrapping a flexible permeable magnetic sheet material in accordance with the present disclosure.

FIG. 20 is a diagrammatic view, in perspective, illustrating details of an embodiment of a wrapping tool that is suitable for use as part of the manufacturing table of FIG. 19, shown here to illustrate details of its structure in accordance with the present disclosure.

FIG. 21 is a diagrammatic view, in perspective, of an embodiment of a bearing plate, two of which are used in the structure of the wrapping tool of FIG. 20 in accordance with the present disclosure.

FIG. 22 is a diagrammatic end view, in elevation, that illustrates the relationship between the various rollers that are part of the wrapping tool of FIG. 20 and its operation for purposes of wrapping the flexible electromagnetically permeable sheet material in accordance with the present disclosure.

FIG. 23 illustrates another embodiment of a pressure sensor end cap, in an elevational view, which can be used in place of pressure sensor end cap 24 of FIG. 1 in accordance with the present disclosure.

FIG. 24 is an exploded view, in elevation, showing the pressure sensor end cap of FIG. 23 in relation to a printed circuit assembly in accordance with the present disclosure.

FIG. 25 is an assembled view, in elevation, showing additional details of the embodiment of the pressure sensor end cap of FIGS. 23 and 24 in accordance with the present disclosure.

FIG. 26 is a diagrammatic view, in perspective, illustrating an embodiment of a filament wrap system for use in producing a wet wrapped tube in the place of the main body tube of FIG. 7.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology such as, for example, up, down, upper, lower, left, right, inner, outer, front, rear and the like may be used with respect to these descriptions, however, this terminology has been adopted with the intent of facilitating the reader's understanding and is not intended as being limiting. Further, the figures are not to scale for purposes of illustrative clarity.

As will be seen, Applicant brings to light a heretofore unknown design which is submitted to resolve the deficiencies of the prior art discussed above and provide still further advantages. The design includes a ductile magnetic core which is highly resistant to mechanical shock and vibration, unlike ferrite materials. The ductile magnetic core provides for an antenna that is substantially the full length of the sonde to provide for efficient locating signal transmission. At the same time, the ductile magnetic core is tubular to define an interior cavity for receiving a battery as well as electronics. The ductile magnetic core includes a sidewall thickness that is remarkably thin such as, for example, ⅛ inch, and which cooperates with other features to maintain an overall peripheral outline of the sonde that fits in an HDD industry-standard drill housing while still providing a relative increase in interior volume to accommodate a relatively larger diameter battery. Current industry standard drill housings can be characterized as defining a battery compartment that is configured to receive a transmitter with a standard diameter of 1.25 inches. Still further improvements will be evident based on the descriptions that follow.

Turning now to the figures wherein like components are indicated by like reference numbers throughout the various figures, attention is immediately directed to FIG. 1 which is a diagrammatic view, in perspective, of an embodiment of a transmitter, generally indicated by the reference number 10, and produced in accordance with the present disclosure. Transmitter 10 can be referred to interchangeably as a sonde and can be used in any suitable inground operation such as, for example, horizontal directional drilling, pullback operations for installing utilities, mapping operations, combinations of these operations and in other types of operations. The terms sonde and transmitter, as used herein, refer to an arrangement that generally includes at least one sensor that produces a sensor signal for external transfer and/or the capability to transmit an electromagnetic locating signal. Transmitter 10 includes a main body 20 which houses a magnetic core, yet to be described. Main body 20 defines opposing end openings that receive a first end cap 24 and a battery end cap 28.

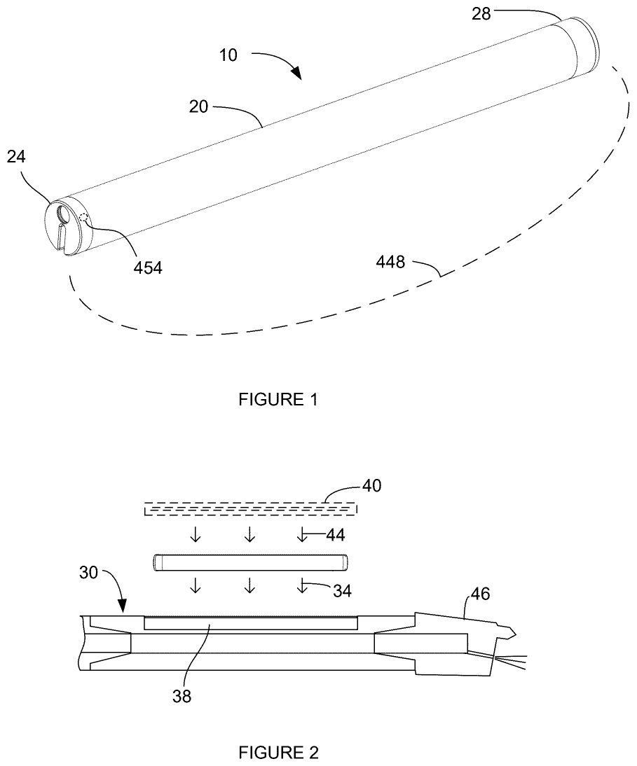

Referring to FIG. 2 in conjunction with FIG. 1, the former is a diagrammatic view, in elevation, illustrating transmitter 10 adjacent to what can be a standard drill housing 30 for installation therein as indicated by arrows 34. Drill housing 30 defines a transmitter compartment 38 for receiving the transmitter. One popular standard drill housing is configured to receive a transmitter having a diameter of 1.25 inches. A cover 40, shown in phantom using dashed lines, is then installed to retain the transmitter within the drill housing as indicated by arrows 44. A drill head 46 is attached to a leading end of drill housing 30.

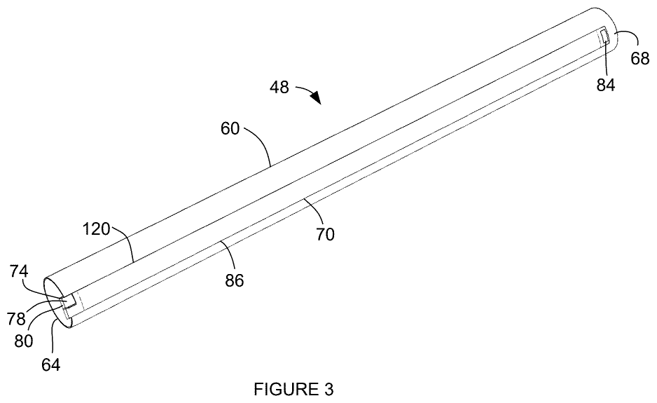

FIG. 3 is a diagrammatic view, in perspective, illustrating an initial step in the production of a ductile magnetic core with reference to an intermediate assembly 48. An inner tube 60 is shown that is elongated between a first end 64 and a second end 68. Inner tube 60 can be cylindrical and formed from a suitable material such as, for example, a fiber reinforced plastic (FRP). A sidewall thickness of inner tube 60 can be of any suitable value such as, for example, 0.02 inches, with the recognition that the sidewall thickness should be as thin as practical for a given material, yet strong enough to tolerate subsequent manufacturing steps, yet to be described, without compromising structural integrity. A flexible printed circuit board (flex PCB) 70 is adhesively affixed to an outer sidewall of inner tube 60 using a suitable adhesive such as, for example, Pressure Sensitive Adhesive (PSA). A pigtail 74 (partially shown) is folded to extend into an interior cavity of the inner tube for connection to an electronics module yet to be described. Flex PCB includes two conductors wherein a first pad 78 is provided for connection of one conductor 80 to one end of an antenna coil (not shown) and a second pad 84 is provided for connection of another conductor 86 to an opposing end of the antenna coil. The thickness of the flex PCB can be, for example, 0.003 inches.

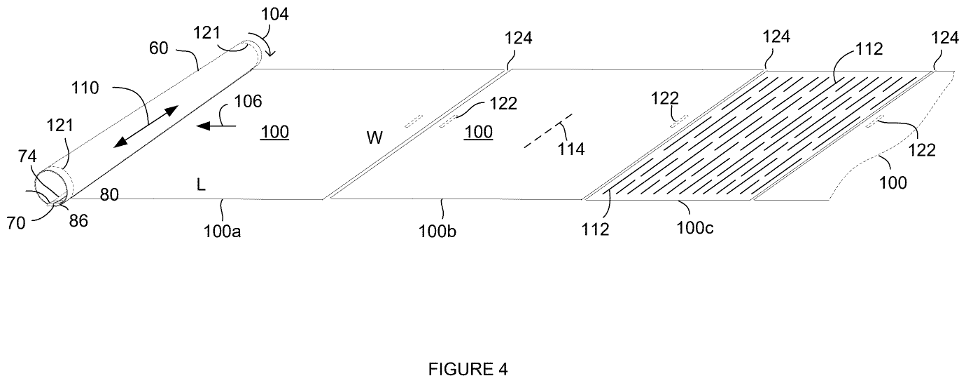

FIG. 4 is a diagrammatic view, in perspective, illustrating inner tube 60 supporting flex PCB 70 with the inner tube arranged to receive a suitable flexible core material either currently available or yet to be developed. In this embodiment, the core material is a flexible permeable magnetic sheet material 100 that is rolled onto the inner tube by rotating the inner tube as indicated by an arrow 104 to advance the sheet material in a direction 106, indicated by another arrow. Rolling the sheet material onto inner tube 60 can be accomplished in any suitable manner such as, for example, by hand rolling or by using a manufacturing table that is described in detail at an appropriate point below. It is noted that three full sheets of material 100 are shown with a third sheet partially shown. In the present embodiment, flexible permeable magnetic sheet material 100 is silicon steel which can be referred to as SiFe for purposes of this disclosure and is often referred to as electrical steel in the literature. The composition of this material is Iron with the addition of about 3.5% silicon, about 0.003% carbon, aluminum limited to 0.5% and manganese limited to 0.5%. It is noted that any suitable formulation can be used either currently available or yet to be developed. Each major surface of the sheet material can receive an electrically insulative coating such as, for example, a ceramic coating to prevent electrical conduction between sheets that are in a stacked relationship. Applicant notes that the use of a flexible electromagnetically permeable sheet material provides a number of remarkable improvements. For example, one improvement resides in enabling the use of a sidewall that is remarkably thin, yet still physically robust. Other examples include providing for ease of manufacturability and ruggedness as compared to the use of the rigid elements or strips seen in the prior art. For instance, any need for a dedicated support structure to hold separate elements in relative position is eliminated. In contrast and as will be seen below, Applicant's design relies on the flexible permeable magnetic sheet material itself to hold flex PCB 70 in place. These benefits are in addition to the enhanced resistance of the flexible permeable sheet material to adverse conditions that are often encountered in the ground such as mechanical shock and vibration. Flexible permeable magnetic sheet material 100, in this embodiment, is grain oriented in a direction 110 that is indicated by a double headed arrow, which is transverse or normal to the direction of rolling to align with an elongated dimension of inner tube 60. It is noted that a non grain oriented sheet material can be used in other embodiments, however, performance may be somewhat degraded. Individual sheets 100 of the flexible permeable sheet material can be of any suitable length L and width W. In this regard, no limitations are imposed such that the length can be greater than the width in some embodiments and, in other embodiments, the width can be greater than the length. It is noted that different sheets may be of different lengths. This sheet material is remarkably flexible as characterized by an ability to conform to a cylindrical surface defined by a diameter at least down to one inch without affecting the magnetic characteristics of the material. In the present embodiment, individual sheets 100a and 100b have a length of at least approximately 14.5 inches, a width of at least approximately 12.5 inches and a thickness of about 1 mil (0.0254 mm or 25.4 microns) including insulative coatings.

Individual sheet 100c is somewhat shorter in length and configured with a plurality of slots 112 that can be arranged in any suitable manner. It is noted that the slots may be useful with respect to the reduction of eddy currents. The slots are formed completely through the sheet material, elongated and sufficiently narrow to prevent eddy currents but need be no wider so as not to significantly adversely influence the permeability of the sheet material. By way of non-limiting example, one suitable slot width is 1/16 inch. The slots can be in a staggered or offset pattern with respect to one another which can further assist in reducing eddy currents as well as to maintain sufficient strength of the sheet material and non-deformability with respect to a wrapping process to which it will be subjected. As shown, the slots can be at least generally aligned with or parallel to grain orientation 110. While only sheet 100c is shown as carrying slots, this is not a requirement. Some embodiments can be configured with all the sheets slotted. Other embodiments can include a mixture of slotted and unslotted sheets such as, for example, every other sheet being slotted while still other embodiments can be configured with no slotted sheets. In some embodiments, a single slot can be formed on one sheet or on each one of multiple sheets. A signal slot is shown in phantom using a dashed line on sheet 100b and indicated by the reference number 114. It is noted that the slots can formed in the sheet material in any suitable manner such as, for example, by punching, laser cutting, water jet cutting and the like. It is noted that the use of slots as described and shown in FIG. 4 is by way of non-limiting example and such slots are not a requirement.

It is noted that Applicant considers sheet materials as being suitable with a flexibility down to at least a minimum bend radius of 0.5 inch without affecting the magnetic characteristics of the material. It should be appreciated that such bending can be characterized as elastic bending. It should be understood that a minimum bend radius refers to the tightest (i.e., smallest radius) bend that the material can be subjected to without compromising the performance of the material in some manner.

Still referring to FIG. 4, a leading edge of the initial sheet of SiFe material can be placed in a confronting relationship with a trailing edge 120 (FIG. 3) of flex PCB 70 to form a gap of approximately 1/16 inch (2 mm) with rolling then proceeding according to arrows 104 and 106. The sheet material includes a width such that its lengthwise edges are spaced away from the ends of inner tube 60, as indicated by dashed lines 121. This arrangement helps to avoid the formation of an additional bump in the resultant wrap. A patch of a suitable adhesive 122 such as, for example, a thin contact adhesive, shown within dashed rectangles, can be applied to leading and trailing edges of sheets 100 to assist in the rolling process. Length L of each sheet 100 can form multiple wraps around inner tube 60 to result in what can be referred to as a stepped spiral wrap. In an embodiment, at least one sheet of SiFe material can form approximately 3 wraps around inner tube 60, although any suitable number of wraps can be formed based, for example, on the desired strength of the magnetic field. It is desirable to form the spiral wrap as tightly as practical against underlying inner tube 60 and/or underlying wraps/layers of the SiFe to avoid gaps or bubbles between layers that would cause the overall magnetic core to be relatively thicker. Subsequent sheets of SiFe sheet material 100 can be added to the overall magnetic core to form at least one gap 124 between confronting edges of the SiFe sheet material in order to reduce the possibility of eddy currents. In the present embodiment, 18 wraps are performed. The result is a cylinder that is annular in its cross-sectional shape. In view of the discussions above, one of ordinary skill in the art will appreciate that a wide range of embodiments can be produced. For example, at least one sheet of SiFe can form at least one wrap around the inner tube as well as any underlying layers. In this regard, an embodiment can use a single sheet of SiFe having a length to form multiple wraps. As another example, at least one sheet of SiFe can form a single wrap around the inner tube and any underlying layers such that the widthwise edges of at least one sheet are in a confronting relationship to form a gap therebetween. Such gaps can be staggered around the periphery of the inner tube and any underlying layers. Of course, in an embodiment with multiple sheets forming a single wrap, the length of the sheet material from one sheet to the next can be increased slightly since the circumference of the overall structure increases from one sheet to the next. In still other embodiments, one or more layers in the overall wrap can be made up of multiple sheets such that each sheet covers only a portion of the overall circumference. For example, two sheets (or any other suitable number) can be used to form a complete wrap such that each sheet covers slightly less than 180 degrees of the overall circumference. In yet other embodiments, combinations of the various embodiments described above can be utilized.

With a 1 mil thickness of the sheet material and 18 wraps, the spiral wrap includes a sidewall thickness that is generally less than 0.02 inch (0.508 mm). Applicant submits that this is remarkably thin, so thin that this cylindrical wrapped tube contributes to the diameter of the transmitter by an essentially negligible amount while still meeting or exceeding performance requirements. In particular, the present embodiment can support a magnetic field at least up to 0.0005 Gauss at a distance of 10 feet without saturating. Of course, the number of wraps and thickness of the SiFe sheets can be tailored to specific applications, with the present embodiment serving by way of non-limiting example.

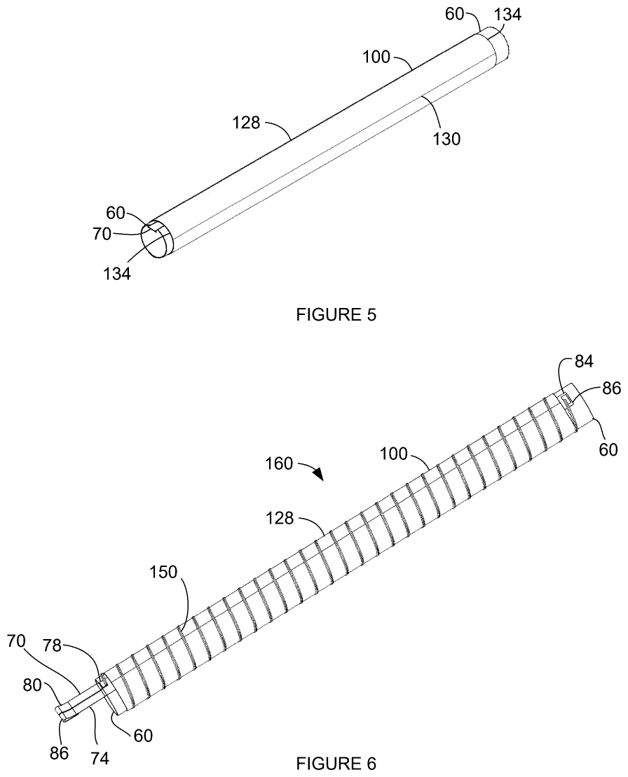

FIG. 5 is a diagrammatic view, in perspective, illustrating that wrapping of flexible permeable magnetic sheet material 100 around inner tube 60 has been completed to form an electromagnetically permeable ductile core 128. The wrapping ends at a trailing edge 130 to leave end portions of the inner tube exposed outward of widthwise edges 134. The resultant shape of the electromagnetically permeable ductile magnetic core is annular in cross-section with an overall cylindrical configuration defining a through passage.

As shown in the diagrammatic perspective view of FIG. 6, the resulting assembly of FIG. 5 receives an antenna coil or winding 150 that is helically wrapped around the assembly. Any suitable magnet wire can be used. One end of the antenna coil is electrically connected to pad 84 (see also FIG. 3) of flex PCB 70 while the opposite end of the antenna coil is electrically connected to pad 78. These electrical connections can be made in any suitable way such as, for example, by soldering. It is noted that pigtail 74 is shown with first and second electrical conductors 80 and 86, respectively. The subject assembly may be referred to as an electromagnetically permeable magnetic core assembly 160.

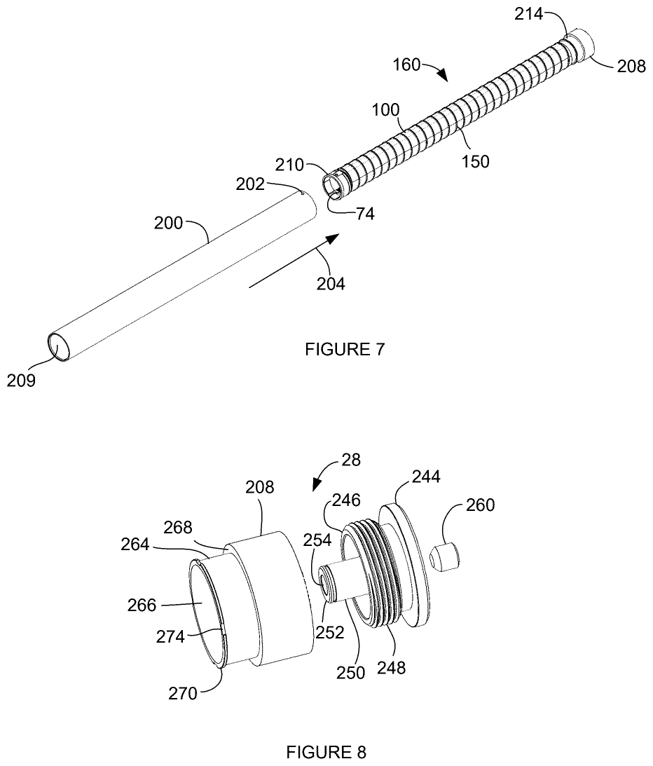

Attention is now directed to FIG. 7 which is a diagrammatic view, in perspective, illustrating electromagnetically permeable ductile magnetic core assembly 160 adjacent to an outer, main body tube 200 with the latter aligned to slidably receive the ductile magnetic core via movement in a direction 204, as indicated by an arrow. Main body tube 200 defines an injection port 202 which will be described below in further detail. A battery end cap receptacle 208 forms part of battery end cap 28 of FIG. 1 and is received on one end of the ductile magnetic core while a centralizer 210 is received on the opposite end of the ductile magnetic core. A suitable adhesive such as, for example, an epoxy can be used to seal battery end cap receptacle 208 to an interior surface of inner tube 60 (see FIGS. 4 and 5). It is noted that main body tube 200 can be cylindrical and formed from any suitable non-magnetic material such as, for example, FRP. The interior diameter of main body tube is sufficient to provide for sliding receipt of the electromagnetically permeable ductile magnetic core assembly with a relatively minimal clearance from antenna coil 150 such as, for example, 0.0005 inch. Battery end cap receptacle 208 defines a sealing flange 214 having a diameter that receives the interior diameter of main body tube 200, as will be further described. It is noted that, with main body tube received against the battery end cap receptacle, an annular cavity is formed between an interior surface 209 of the main body tube and the exterior periphery of electromagnetically permeable ductile magnetic core assembly 160.

FIG. 8 is a diagrammatic exploded view, in perspective, illustrating an embodiment of a battery end cap 28 as an assembly that includes battery end cap receptacle 208 which serves as an intermediate body that is configured with threads to threadably receive a removable battery cap 244. The latter itself includes an annular inner end 246 that defines threads 248 for sealingly engaging complementary threads (not visible in the present view) within the battery end cap receptacle. It is noted that removable battery cap 244 is not installed in the view of FIG. 7 in order to accommodate a subsequent manufacturing step. As seen in FIG. 7, battery end cap receptacle 208 is fixedly attachable to one end of the overall transmitter while removable battery cap 244 is removably attachable to facilitate the removal and replacement of a battery pack interior to the transmitter. Embodiments of the battery pack can include any suitable battery chemistry including, for example, lithium based batteries, alkaline batteries and battery chemistries yet to be developed. Accordingly, removable battery cap 244 is near the battery pack during operation of the transmitter. The end cap further includes a center tubular post 250 that is configured to engage a battery extractor spacer that will be described in further detail at an appropriate point hereinafter. Center tubular post 250 extends from an outer, closed end of the removable battery cap through and at least somewhat beyond annular inner end 246 to a distal inner end 252 thereby defining a through passage 254 leading from the distal inner end to an aperture that is formed in the outer, closed end. The aperture is configured to receive a thermal safety plug 260 within the through passage in any suitable manner such as, for example, using threaded engagement or a pressed fit. Thermal safety plug 260 includes a predetermined failure temperature such that the transmitter interior cavity is pressure isolated from the ambient environment during operation of the transmitter which subjects the thermal safety plug to temperatures below the predetermined failure temperature and, above the predetermined failure temperature, the thermal safety plug releases or vents an internal pressure of the transmitter interior cavity to the ambient environment. The thermal safety plug can be formed from a material that will melt or fail responsive to a thermal runaway, for example, of a lithium based battery pack. Suitable materials for the thermal safety plug include but are not limited to nylon, polycarbonate and thermoplastics. Therefore, in the event of a thermal runaway, internal pressure buildup within the interior of the transmitter is released via through passage 254 responsive to melting of thermal safety plug 260 to avoid any potential explosion hazard.

Still referring to FIG. 8, battery end cap receptacle 208 includes a flange 264 defining an inner passage 266 that receives an end portion of inner tube 60 (see FIGS. 3 and 4), for example, against an annular step that is not visible in the current view. Main body tube 200 (FIG. 7) is slidably received to abut against an annular face 268. It is noted that this positions injection port 202 in a confronting relationship with flange 264. A distal end of flange 264 includes an outwardly projecting lip 270 that serves to center the battery end cap receptacle within main body tube 200. Outwardly projecting lip 270 defines a suitable number of spaced apart gaps 274, the function of which will be described at an appropriate point hereinafter. In the present embodiment, four gaps 274 are provided. It is noted that battery end cap receptacle 208 and removable battery cap 244 can be formed from any suitable material such as, for example, non-corroding steel. Moreover, there is no requirement to form both the battery end cap receptacle and the removable battery cap from the same material.

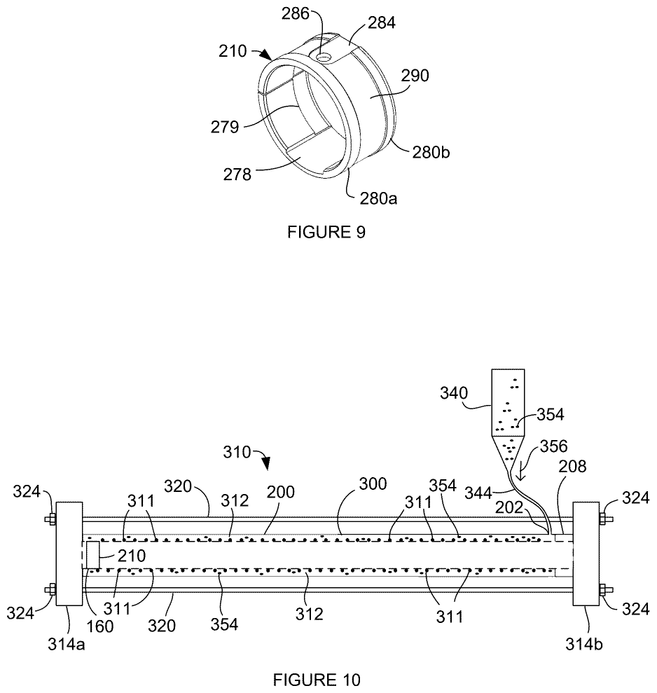

Attention is now directed to FIG. 9 in conjunction with FIG. 7 wherein the former is a diagrammatic view, in perspective, of centralizer 210 which is used at the end of the transmitter opposite end cap assembly 28. The centralizer is receivable on an end portion of inner tube 60 providing a channel 278 for passage of flex PCB 70 (see FIG. 6). An end face of inner tube 60 abuts against a peripheral edge 279 with the centralizer installed. A pair of annular rings 280a and 280b project outwardly to engage an inner surface of main body tube 200. A recess 284 leads to a vent port 286 passing through a gap in annular ring 280b. An annular flow channel 290 extends around the periphery of the centralizer at a level that is intermediate between an outer diameter of annular rings 280a/b and recess 284. Thus, an encapsulant material vent path is provided from an annular cavity that is defined between the interior surface of main body tube 200 and the outer periphery of electromagnetically permeable ductile magnetic core assembly 160, as will be further described.

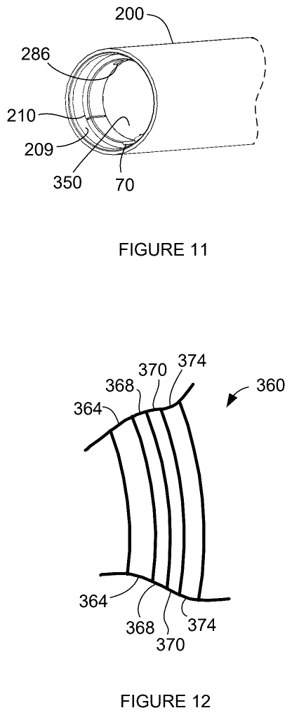

Once main body tube 200 is in its final position, the result of FIG. 7 is an intermediate assembly that is ready for an encapsulation procedure. FIG. 10 is a diagrammatic view, in elevation, showing the subject intermediate assembly, generally indicated by the reference number 300, received in a clamping arrangement that is generally indicated by the reference number 310. This intermediate assembly includes ductile magnetic core assembly 160 (shown in phantom using dashed lines) and main body tube 200 such that an annular cavity 312 is defined between the interior surface of the main body tube and the outer periphery of electromagnetically permeable ductile magnetic core assembly 160. The clamping arrangement includes end blocks with a first end block 314a sealingly engaging the end of the intermediate assembly proximate to centralizer 210 and a second end block 314b sealingly engaging battery end cap receptacle 208. Clamping can be accomplished, for example, by using a suitable number of threaded clamping rods 320 with nuts 324 threaded onto the clamping rods to engage the end blocks. In the present embodiment, four clamping rods are used. An injection pump 340 is coupled to tubing 344 that is, in turn, coupled to injection port 202 (see FIG. 7). FIG. 11 is a diagrammatic cut away partial view, in perspective, illustrating the appearance of the end of the intermediate assembly that is engaged by end block 314a, showing centralizer 210 and vent port 286. Flex PCB 70 is also at least partially visible. An interior surface of inner tube 60 is indicated by the reference number 350.

Continuing to refer to FIG. 10, injection pump 340 injects an encapsulant material 354 into injection port 202 via tubing 344 in a direction 356 indicated by an arrow. The encapsulant material flows around flange 264 (FIG. 8) of end cap receptacle 208 to seal and bond main body 200 to the end cap receptacle. The encapsulant material also flows through gaps 274 to enter annular gap 312, flow around windings 311 and contact exposed portions of flexible permeable magnetic sheet material 100 and exposed end portions of inner tube 60 as well as flex PCB 70 (FIG. 6) to create an encapsulated assembly. In an embodiment, the encapsulant material can also bond or adhere to one or all of the flexible permeable magnetic sheet material, end portions of inner tube 60, antenna windings 311 and an interior surface of main body tube 200. It is noted that the quality of bonding is responsive, for example, to the similarity and chemistry of surfaces involved as well as the chemistry of the encapsulant material when intended to serve as a bonding agent. If bonding to any particular one of these components is not desired in other embodiments, that component can be masked to prevent contact with the encapsulant material. For example, if masking that is impervious to the encapsulant material is applied to the outer surface of a particular component, the encapsulant will not bond to the particular component. In this regard, masking intermediate assembly 310 can result in main body tube 200 being removably replaceable on the intermediate assembly. In still another embodiment, intermediate assembly 300 can be placed in a mold for encapsulation such that the interior periphery of the mold matches the interior periphery of main body tube 200. The latter can then be removably installed onto the encapsulated intermediate assembly such that the main body tube is replaceable.

Still referring to FIG. 10, it is noted that the pigtail end 74 of flex PCB 70 (FIG. 7) can be folded into the interior passage of inner tube 60 during the encapsulation process. Upon reaching centralizer 210, the encapsulant material flows from annular gap 312 into recess 284 (FIG. 9) to reach vent port 286. At the same time, the encapsulant material flows around annular flow channel 290 to bond centralizer 210 to the interior surface of main body tube 200. Once essentially all air has been vented and the encapsulant material is flowing through vent port 286 to the interior of the centralizer, the injection process is complete. Any vented encapsulant material can subsequently be removed upon removal of the assembly from clamping arrangement 310. Any suitable encapsulant can be used, either currently available or yet to be developed such as, for example, an epoxy.

It is noted that in another embodiment the resultant intermediate assembly of FIG. 7 can be used in a transmitter without encapsulation. That is, an encapsulation procedure is not a requirement. Accordingly, features that are dedicated to the encapsulation process are not required such as, for example, injection port 202, recess 284 (FIG. 9), vent port 286 and flow channel 290. In this regard, the wrapping procedure of FIG. 4 can result in electromagnetically permeable ductile core assembly 160 having sufficient structural integrity, for example, due to the tightness of the wrap as well as tightly winding antenna coil 150 so as to further strengthen the overall assembly. Some embodiments can also receive an electrical varnish over the antenna coil and underlying flexible permeable magnetic sheet material 100.

FIG. 12 is a diagrammatic cut through and further enlarged view, in elevation, showing the structure of a sidewall of intermediate assembly 310 of FIG. 10 post encapsulation, generally indicated by the reference number 360 and not to scale. In particular, an innermost layer 364 comprises inner tube 60 (see FIGS. 3-6). A ductile flexible magnetic core layer 368 comprises flexible permeable magnetic sheet material 100 (see FIGS. 4-7). An antenna/encapsulant layer 370 includes antenna coil 150 (see FIGS. 6, 7 and 10) as well as encapsulant 354 (see FIG. 10). An outer layer 374 comprises main body tube 200 (see FIGS. 7, 10 and 11).

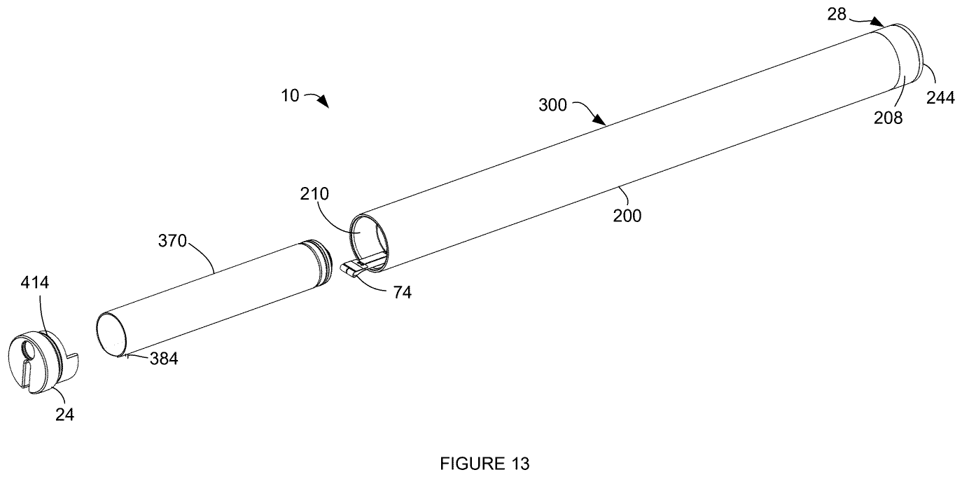

FIG. 13 is a diagrammatic, partially exploded view of transmitter 10, shown here to illustrate further details with respect to assembly. In particular, encapsulated intermediate assembly 300 is shown with pigtail 74 of flex PCB 70 extending outward from the interior of the intermediate assembly. An electronics package 370 is shown adjacent to the encapsulated intermediate assembly. Once the latter is partially received in the axial cavity of intermediate assembly 300, pigtail 74 can be electrically connected to electrical pins 384 that extend from the bottom of the electronics package to electrically interface, now encapsulated antenna coil 150 (FIG. 7), with the electronics package. In this way, pigtail 74 folds into the axial cavity as the electronics package is fully received therein. First end cap 24 is sealed onto the intermediate assembly, for example, by using an O-ring 414 and a mechanical fastener and/or a suitable adhesive. It is noted that this process is essentially unchanged if the intermediate assembly is not encapsulated.

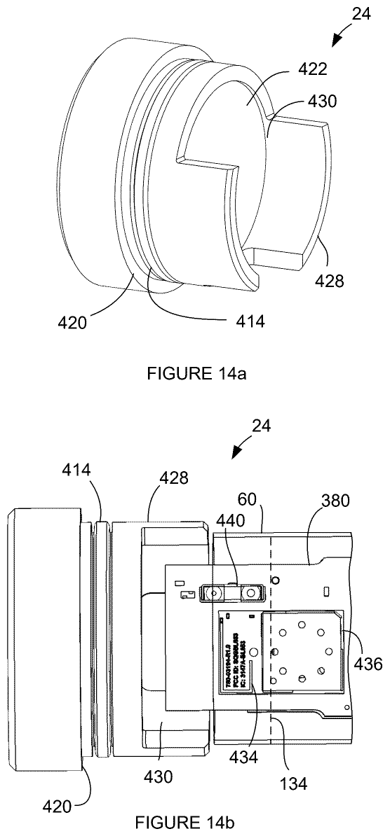

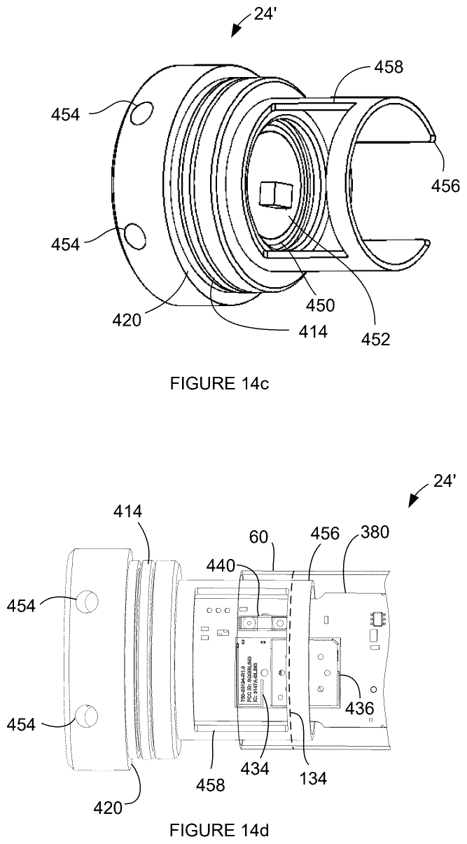

Attention is now directed to FIGS. 14a and 14b which are diagrammatic views of first end cap 24. FIG. 14a is a perspective view while FIG. 14b is a diagrammatic cut away plan view of the end of transmitter 10 with first end cap 24 installed. In the view of FIG. 14b, inner tube 60 has been rendered as transparent while all other structure outward of the inner tube is not shown including ductile flexible magnetic core layer 368, antenna/encapsulant layer 370 and outer layer 374 (see FIG. 12). The housing of electronics package 380 (FIG. 13) has also been hidden for purposes of illustrating its componentry proximate to the first end cap. Outer widthwise edge 134 (FIG. 5) of flexible permeable magnetic sheet material 100 is indicated by a dashed line. As described above, O-ring 414 seals against an inner surface of main body tube 200 (FIG. 13) with an end face of the latter received against an annular face 420 of the first end cap. The first end cap includes a solid core 422 extending to a distal end. The first end cap further includes an annular skirt 428, which may be referred to interchangeably as a sleeve, that defines a gap 430. An end portion of the electronics package can be received within annular skirt 428 such that an integral antenna 434 of a radio frequency transceiver 436 is spaced away from edge 134 to facilitate external radio frequency (RF) communication. In an embodiment, RF transceiver 436 can utilize Bluetooth technology, although any suitable technology can be used. An optical port 440 includes an optical detector/transmitter pair that can also be positioned in an at least partially confronting relationship with gap 430 to provide for external bidirectional optical communications, for example, utilizing infrared technology such as IRDA. It is noted that RF and optical communications can readily pass through any elements outward of the optical port and antenna 434 such as, for example, encapsulant material 354, main body tube 200 and inner tube 60. Thus, external RF and/or optical communications can be available even with a flexible magnetic core that very nearly covers the full axial length of the transmitter. Accordingly, first end cap 24 may be referred to interchangeably as a multi-com end cap. Such a configuration provides for enhancement of the signal strength of an electromagnetic locating signal 448 (FIG. 1) represented by a dashed line which can be a dipole signal. Of course, this enhancement results in the ability to reduce the consumption of battery power while maintaining a given signal strength of the locating signal. It should be appreciated that other embodiments may be readily be configured with one or the other of external RF and optical communications in light of the present disclosure.

Attention is now directed to FIGS. 14c and 14d which are diagrammatic views of another embodiment of the first end cap, generally indicated by the reference number 24′, which may be referred to interchangeably as a pressure sensor end cap. FIG. 14c is a perspective view while FIG. 14d is a diagrammatic cut away plan view of the end of transmitter 10 with pressure sensor end cap 24′ installed. Given that pressure sensor end cap 24′ shares many features of its structure with first end cap 24 descriptions of such features may not be repeated for purposes of brevity. In this regard, the same elements of the transmitter that were rendered as transparent or were hidden in FIG. 14b are also rendered as transparent or hidden in FIG. 14d. It is noted that approaches for incorporating a pressure sensor in an end cap can be seen in U.S. Patent no. 8,662,200, ENTITLED SONDE WITH INTEGRAL PRESSURE SENSOR AND METHOD, which is commonly owned with the present application and incorporated herein by reference.

Pressure sensor end cap 24′, in this embodiment, defines an aperture 450 which receives a pressure sensor 452. Pressure ports 454 lead into passages that provide ambient pressure to a pressure membrane of the pressure sensor. It is noted that one pressure port 454 is shown in phantom in FIG. 1 using a dashed ellipse. The pressure sensor end cap includes an annular skirt 456, which may be referred to interchangeably as a tubular sleeve, that defines a window 458 outward of electromagnetically permeable ductile core assembly 160 (FIG. 7) and edge 134. An end portion of the electronics package can be received within annular skirt 428 such that integral antenna 434 of radio frequency transceiver 436 is in a confronting relationship with window 458 to facilitate external radio frequency (RF) communication since such RF communications can readily pass through encapsulant material 354, main body tube 200 and inner tube 60. In an embodiment, RF transceiver 436 can utilize Bluetooth technology although any suitable technology can be used. Optical port 440 can also be positioned in a confronting relationship with window 430 to provide for external bidirectional optical communications.

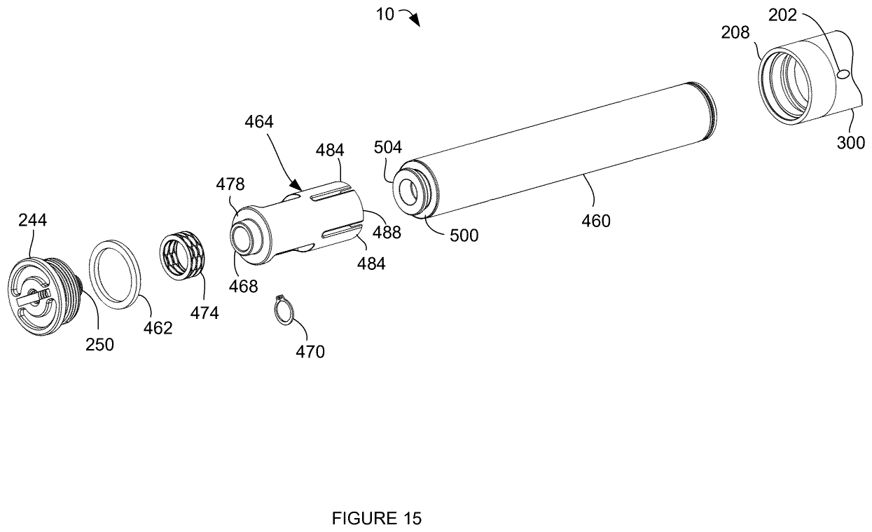

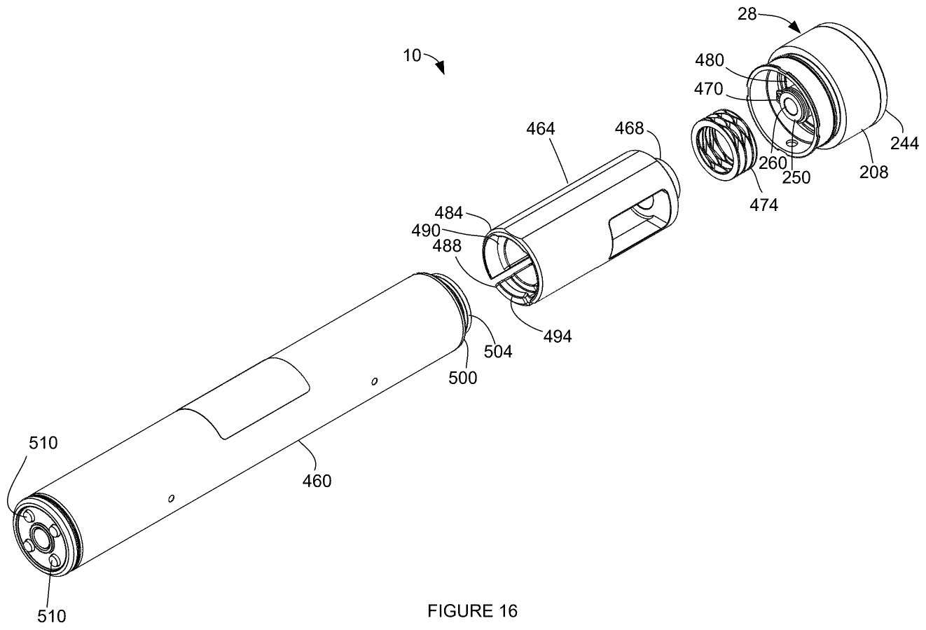

Attention is now directed to FIGS. 15 and 16. FIG. 15 is a diagrammatic exploded view, in perspective, illustrating the relationship between removable battery cap 244 and additional components relating to a battery pack 460 that is removably receivable within encapsulated intermediate assembly 300 (partially shown). FIG. 16 is another diagrammatic exploded view, shown here to illustrate additional details of the various components from a different perspective view than that of FIG. 15. As described above and in the present non-limiting embodiment, battery end cap 28 is made up of battery end cap receptacle 208 and removable battery cap 244 which are shown in an assembled state in FIG. 16. A seal (not visible) such as, for example, an O-ring is receivable on battery end cap 244 to seal the latter to battery end cap receptacle 208. As will be seen, a battery extractor spacer 464 includes an end hub 468 that is slidably receivable on center tubular post 250 (also shown in FIG. 8) of removable battery cap 244. The battery extractor spacer has a diameter that can pass through the central opening of battery end cap receptacle 208 and can be retained on post 250 by a C-clip 470. A wave spring 474 is received on hub 468 of the battery extractor spacer, prior to installing the extractor spacer onto post 250 such that the wave spring is compressed between an end face 478 of the battery extractor spacer and an interior floor 480 of the removable battery cap which surrounds center tubular post 250. It is noted that battery extractor spacer 464 includes a length that is customized to accommodate the length of the particular battery pack that is in use. In the present example, a relatively long extractor spacer is used with a relatively short battery pack. Accordingly, battery packs can be used having different capacities and lengths by using different length battery extractor spacers.

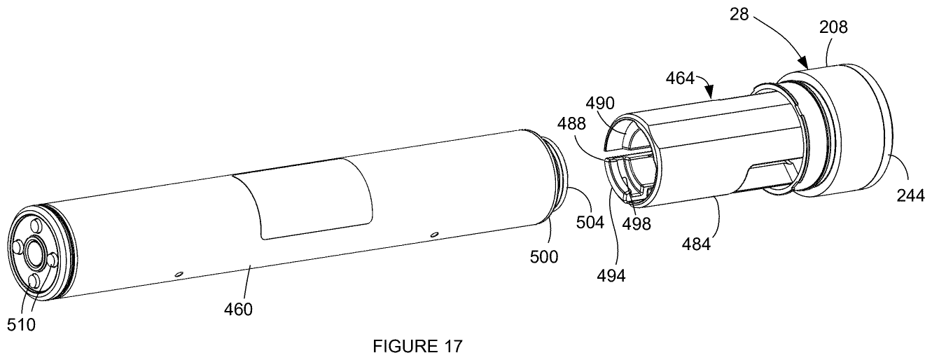

With primary reference to FIG. 17 in conjunction with FIGS. 15 and 16, the former is a diagrammatic view, in perspective, illustrating details of battery extractor spacer 464 arranged for coupling to battery pack 460 preparatory to installation in the transmitter. Battery extractor spacer 464 includes an elongated C shaped sidewall 484 that is separated by gaps from an arcuately shaped resilient latching arm 488. A distal end of C shaped sidewall 484 defines a seat 490 that is engaged by a peripheral annular rim of battery pack 460. A free end 494 of latching arm 488 includes an inwardly projecting latching rim 498. Battery pack 460 includes a latch cap 500 that is configured with a T-shaped head 504 in an elevational view. Battery pack 460 is removably coupled to battery extractor spacer 464 by inserting T-shaped head 504 into the end opening of the battery extractor spacer until the battery pack engages seat 490 and latching rim 498 resiliently passes over and latches onto T-shaped head 504. In the present embodiment, battery extractor spacer 464 and battery pack latch cap 500 are configured to cooperate such that the battery pack can be installed in two different ways. In a first way, the extractor spacer can be installed on the battery pack prior to insertion into the cavity of the transmitter such that removable battery cap 244, the extractor spacer and the battery pack can be installed in the transmitter as a unit. In a second way, battery pack 460 can first be slidably installed in the transmitter cavity followed by installing battery extractor spacer along with removable battery cap 244 to cause the battery extractor spacer to latch onto the battery pack interior to the transmitter cavity. In another embodiment, battery extractor spacer 464 and battery pack latch cap 500 are configured to cooperate such that the battery pack can only be installed in the transmitter cavity as a unit. That is, the extractor spacer must be latched onto the battery pack exterior to the transmitter and installed as unit with such latching unavailable interior to the transmitter cavity. The latter embodiment can be designed, for example, with latching rim 498 extending further inward such that the latching rim is unable to pass over T-head 504 when the battery pack is received in the battery compartment of the transmitter due to a limited available amount of resilient outward deflection of latching arm 488. The combination of removable battery cap 244 and battery extractor spacer 464 along with associated components may be referred to as a battery end cap extractor for purposes of this disclosure and the appended claims.

Still referring to FIGS. 15-17, when battery pack 460 is fully received in the transmitter, electrical contacts 510 (several of which are individually designated) are engaged to provide electrical power to electronics package 380. Responsive to installation of removable battery cap 244, wave spring 474 is compressed, given that battery extractor spacer 464 is slidably received on center post 250. In this way, a resilient force biases the battery pack towards electronics module 380 (FIG. 13) to reduce the likelihood of loss of electrical contact between the battery pack and the electronics module causing associated power interruptions, for example, responsive to mechanical shock and vibration during drilling. It is noted that embodiments of the battery end cap extractor brought to light herein are capable of applying at least 0.5 pounds of force for purposes of extracting the battery pack. It is noted that battery extractor spacer 464 can be formed from any suitable material including, but not limited to poly carbonate, glass filled nylon or POM, for example, as well as blends of poly carbonate and other materials such as, for example, acrylonitrile butadiene styrene.

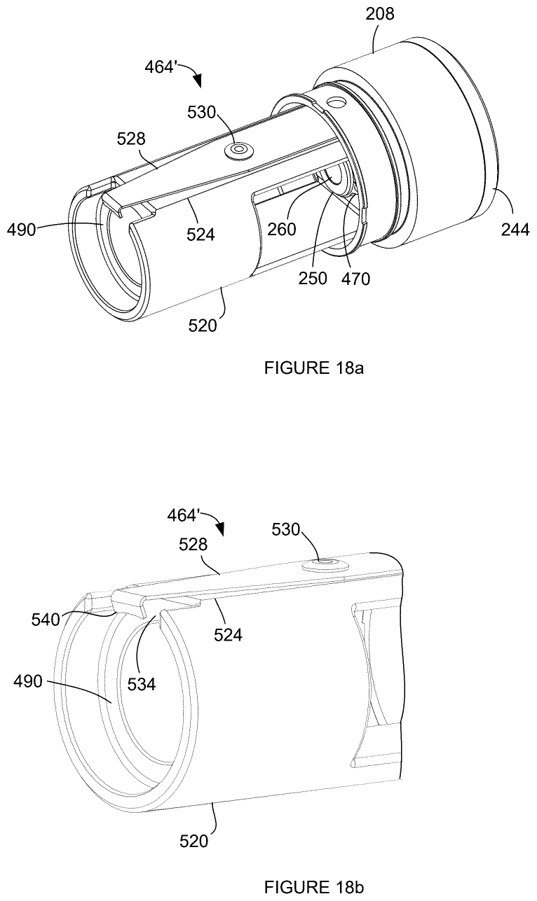

Attention is now directed to FIG. 18a which is a diagrammatic view, in perspective, of another embodiment of a battery extractor spacer, generally indicated by the reference number 464′. In this embodiment, a spacer body 520 is shown connected to removable battery cap 244 in the same manner as previously described battery extractor spacer 464 using post 250 and C clip 470. Thermal safety plug 260 is also visible. Spacer body 520 defines a channel 524 which receives a spring arm 528 that can be held in position, for example, by a suitable fastener 530 such as a rivet.

Referring to FIG. 18b in conjunction with FIG. 18a, the former is a further enlarged and partially cutaway view, in perspective of a distal end of battery extractor spacer 464′, shown here to illustrate further details of its structure. Spacer body 520 defines a notch 534 such that a latching tab 540 formed at a free end of spring arm 528 can be positioned at least partially within the notch. Latching tab 540 is configured to engage T-shaped head 504 of latch cap 500 in essentially the same manner as latching rim 498 of resilient latching arm 488 (FIG. 17) given that spring arm 428 is formed from a resilient metal material such as, for example, spring steel. Accordingly, battery extractor spacer 464′ and battery pack latch cap 500 can be configured to cooperate such that battery pack 460 can be engaged and installed in two different ways as described above with regard to battery extractor spacer 464. It is noted by way of non-limiting example that latching tab 540 can be integral to spring arm 528 and formed, for example, by bending. It is noted that battery extractor spacer body 520 can be formed from any suitable material including, but not limited to the same materials used to produce extractor spacer 464.

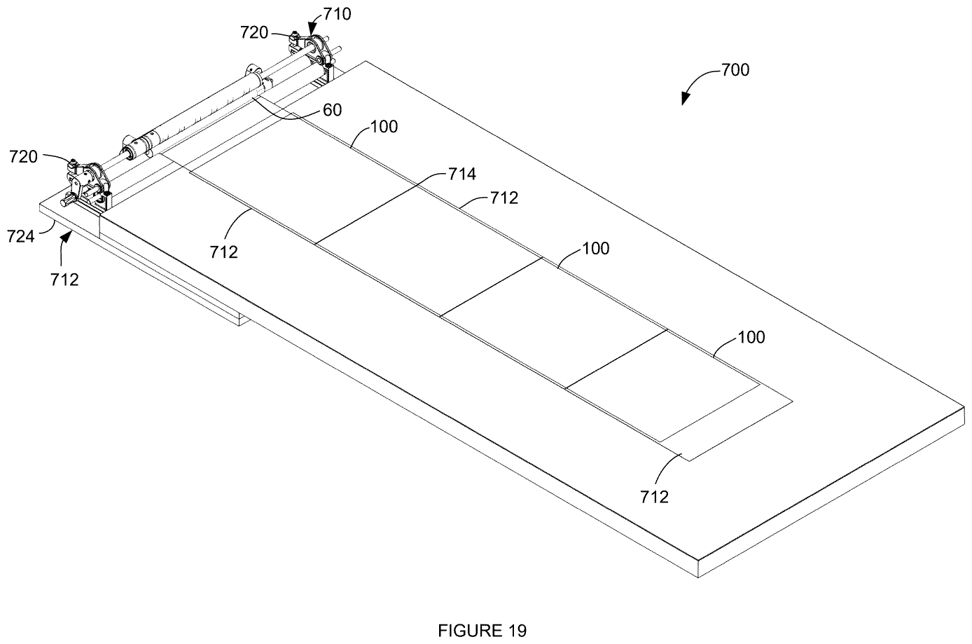

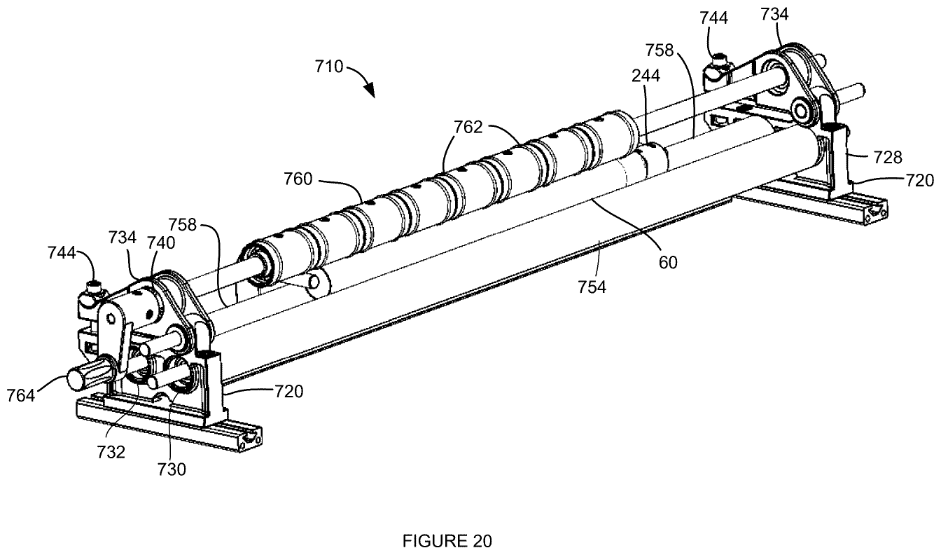

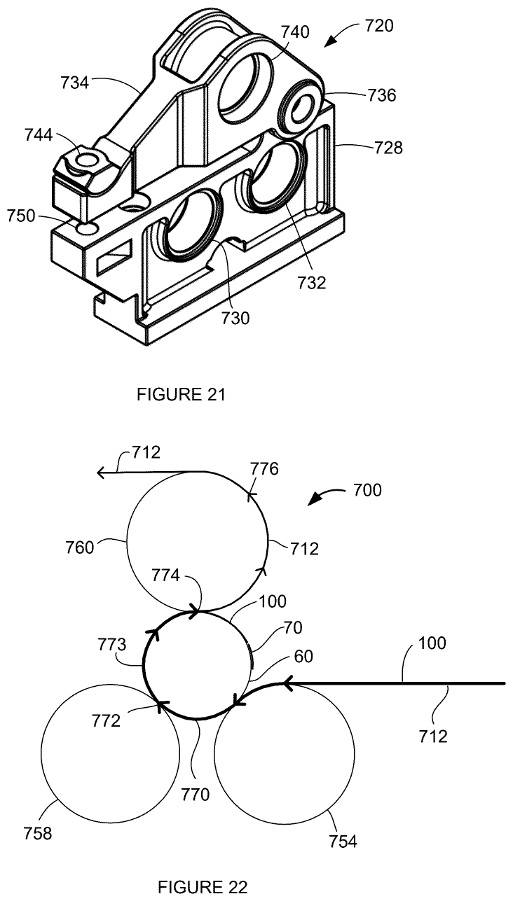

FIG. 19 is a diagrammatic view, in perspective, illustrating an embodiment of a manufacturing table, generally indicated by the reference number 700, which facilitates the process depicted by FIG. 4 for wrapping flexible permeable magnetic sheet material 100 onto inner tube 60 which serves as a workpiece and may be referred to interchangeably as a core tube. FIG. 20 is a further enlarged diagrammatic view, in perspective, illustrating details of a wrapping tool or apparatus 710 in isolation from the remainder of the manufacturing table and shown here to illustrate details of its structure. FIG. 21 is a diagrammatic view, in perspective, of a bearing plate, generally indicated by the reference number 720, two of which are used in the structure of wrapping tool 710. Each bearing plate is fixedly attached to a table 724, as seen in FIG. 19. Each bearing plate includes a base plate 728 defining front and rear bearing apertures that receive front and rear bearings 730 and 732, respectively. A pivot plate 734 is pivotally hinged to base plate 728 at 736 in any suitable manner such as, for example, by a pin. Pivot plate 734 defines a bearing aperture that receives a pivot plate bearing 740. In an embodiment, bearings 730, 732 and 740 can be the same part number such as, for example, a standard sealed 608-2RS bearing. A threaded fastener 744 (FIG. 20) can be received through an opening 748 in pivot plate 734 and threaded into another opening 750 in base plate 728 to hold and bias the pivot plate to a closed position. Bearing plates 720 can be formed from any suitable material including but not limited to plastic, metal or wood.

FIG. 20 illustrates a first, front roller 754 and a second, rear roller 758 installed between the base plates using front and rear bearings 730 and 732, respectively. It is noted that the front and rear rollers are idler rollers that are not driven and can be formed from any suitable material such as, for example, plastic, metal, wood or rubber. A driven roller 760 is supported between pivot plates 734 using bearings 740. In an embodiment, the driven roller as well as the front and rear roller shafts can be of the same diameter and formed from the same material, although any other suitable configuration can be used. In the present embodiment, driven roller 760 is formed, for example, from steel rod, a plastic roller or rubber grippers. In the present embodiment, the driven roller supports a plurality of resilient O-rings 762. A hand crank 764 is coupled to driven roller 760 for turning the driven roller. In some embodiments, a motor can be used in place of a hand crank. During operation, inner tube 60 with the flex PCB (FIG. 3) and battery end cap receptacle 208 can serve as a workpiece. This assembly is initially placed on front and rear rollers 754 and 758 with pivot plates 734 in an open position. The pivot plates are then pivotally closed to capture inner tube 60 between the three rollers.

Referring to FIG. 19 in conjunction with FIG. 22, the latter is a diagrammatic end view, in elevation, that illustrates the relationship between the various rollers that are part of apparatus 710 and the workpiece being subject to its operation for purposes of wrapping flexible permeable magnetic sheet material 100. It is noted that wrapping tool 710 is not limited to wrapping the flexible permeable magnetic sheet material but can be utilized to wrap any desired flexible sheet material onto a support tube. It is further noted that sheets 100 are not slotted in the embodiment of FIG. 19, although the apparatus can be used if one or more sheets bear slots. It should be appreciated that a triangle (not shown to avoid illustrative confusion but easily envisioned) is defined between the rotational axes of the front roller, the second roller and the driven roller in the form of an isosceles triangle with equal sides extending from the driven roller axis to each of the front and rear roller axes. Prior to the wrapping operation, pieces of flexible permeable magnetic sheet material 100 are laid out on a carrier sheet 712 which can be a heavy paper such as, for example, freezer paper, thin stainless steel layer or polymer sheeting (plastic, mylar and the like.). As seen in FIG. 4, temporary adhesive 122 can be used to hold the flexible permeable magnetic sheet material to the carrier sheet with a gap 714 between confronting widthwise edges that is sufficiently wide to avoid conduction of eddy currents between adjacent sheets. As seen in FIG. 22, the table can support the combination of the carrier sheet and the flexible permeable magnetic sheet material at a height that is at least approximately aligned with the top of front roller 754. As the hand crank is turned, a leading edge of the carrier sheet is fed into the space between inner tube 60 and front roller 754 adjacent to a trailing edge of flex PCB 70. These two layers are compressed between the first roller and the core tube and then travel on a path segment 770, indicated as a heavy black line 770 with arrowheads, around inner tube 60 to a point 772 which contacts second roller 758 for compression between the second roller and the core tube. The flexible permeable magnetic sheet material and carrier sheet then travel on a path segment 773 to a point 774 which contacts drive roller 760.

At point 774, flexible permeable magnetic sheet material 100 is separated from carrier sheet 712 with the latter passing around driven roller 760 and traveling around a portion of the periphery of the driven roller on a path segment 776 to then exit the wrapping operation while the flexible permeable magnetic sheet material wraps around inner tube 60. As carrier sheet 712 is advanced, any suitable number of sheets of flexible permeable magnetic sheet material 100 can be wrapped onto the inner tube to form a helical wrap. Upon completion of the wrap, pivot plates 734 can be released to remove the wrapped inner tube. Manufacturing table 700 has been found to produce an evenly wound core structure with few bubbles or interstitial gaps between successive layers. In another embodiment, the length of the sheets of flexible permeable magnetic sheet material 100 can progressively increase by an incremental about such that each sheet forms a single layer in the wrapped structure. Individual sheets 100 can be laid out on carrier sheet with gap 712 between adjacent sheets customized such that the gaps are staggered in the overall final core structure.

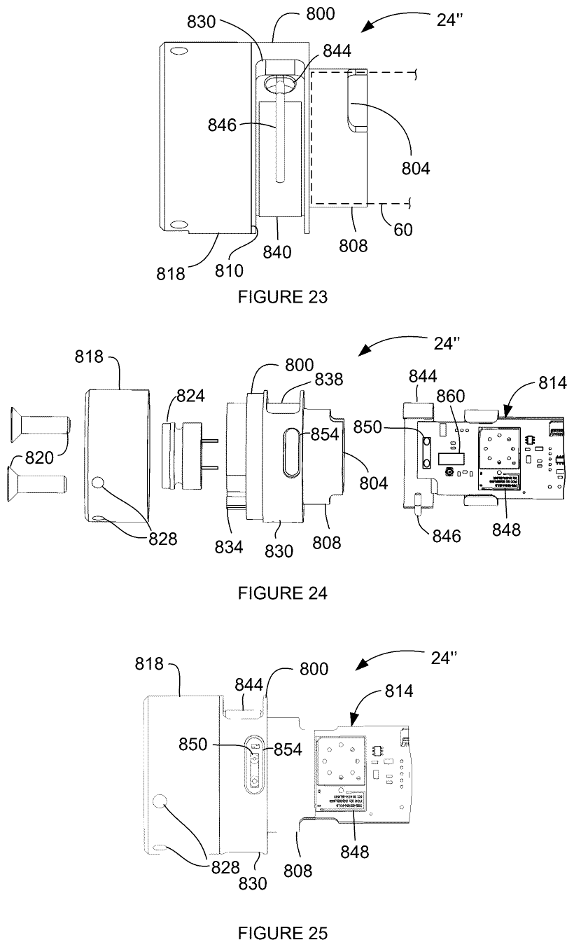

Attention is now directed to FIG. 23 which illustrates another embodiment of a pressure sensor end cap in an elevational view, generally indicated by the reference number 24″ which can be used in place of pressure sensor end cap 24′ as seen, for example, in FIGS. 14c and 14d. Pressure sensor end cap 24″ includes a main body 800 that defines an interior cavity 804. The main body includes an inward end 808 configured as a tubular sleeve for receiving inner tube 60 (partially shown in phantom using dashed lines) in sealed engagement such that the inner tube abuts a collar 810.

Referring to FIGS. 24 and 25 in conjunction with FIG. 23, the former is an exploded view, in elevation, showing pressure sensor end cap 24″ in relation to a printed circuit assembly 814 which is itself partially shown while FIG. 25 is an assembled view. It is noted that components which would obstruct the view of the items of interest in FIG. 25 have been rendered as transparent such as, for example, inner tube 60, centralizer 210 and main body tube 300. Main body 800 is engagable by a cover 818 that can be secured using threaded fasteners 820. A pressure sensor 824 is receivable in an aperture that is defined by main body 800 such that removal of cover 818 allows replacement of the pressure sensor. Pressure ports 828 provide a path to conduct ambient pressure to a pressure sensor membrane (not visible in FIG. 24) on a leading surface of the pressure sensor. A peripheral sidewall configuration 830 surrounds interior cavity 804 between inward end 808 and an outward end 834 of the main body, the peripheral sidewall configuration defines an inset floor 838 for supporting a radio frequency antenna 840 and the inset floor includes a feedthrough 844 leading to the interior cavity for routing an electrical conductor 846 therethrough to electrically connect the radio frequency antenna to a radio frequency transceiver 848 that forms part of printed circuit assembly 814 housed within the transmitter for external radio frequency communication. In an embodiment, radio frequency transceiver 848 can be a Bluetooth™ transceiver, however, any suitable technology can be used. It is noted that the recess containing antenna 840 can be filled with an abrasion resistant potting material such as, for example, an epoxy ceramic hybrid.

Turning to FIG. 25 in conjunction with FIG. 24, details will now be provided with respect to bidirectional optical communications. FIG. 25 shows an end portion of the transmitter with part of printed circuit assembly 814 received in interior cavity 804 such that an optical transceiver pair 850 is in a confronting relationship with an optical port 854 that is defined by the peripheral sidewall configuration of main body 800 and in electrical communication with an optical transceiver 860 (FIG. 24). In an embodiment, the optical communications can be infrared. Optical port 854 can also be filled with an abrasion resistant potting material such as, for example, a material that allows bidirectional passage of optical communications such as, for example, polycarbonate, borasilicate glass and the like. Accordingly, it should be appreciated that pressure sensor end cap 24″ facilitates both optical and radio frequency communication regimes from the end cap while being spaced away from electromagnetically permeable ductile core assembly 160 and without requiring any reduction in the length of the core that would adversely affect the efficiency of locating signal 448 transmission (FIG. 1).

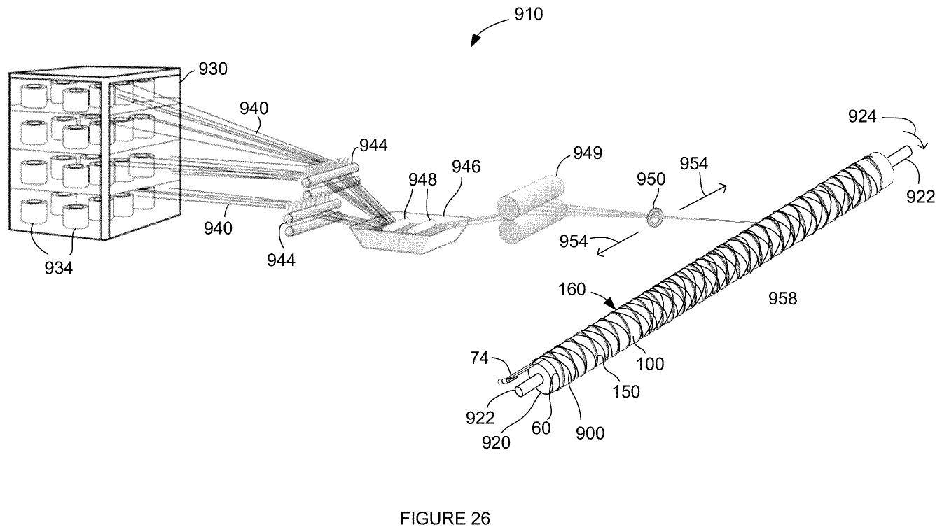

In another embodiment, main body tube 200 of FIG. 7 can be replaced by a wet wrapped tube 900 that is shown undergoing formation in FIG. 26. The latter is a diagrammatic view, in perspective, illustrating an in situ filament wind system, generally indicated by the reference number 910, with electromagnetically permeable ductile magnetic core assembly 160 (FIG. 7) as a workpiece. It is noted that there is no requirement for filament winding. The wet wrap can be performed in any suitable manner such as, for example, by hand rolling, through the use of an electric motor or related apparatus. Pigtail 74 of the flex PCB can be folded into the central cavity of inner tube 60. Ductile magnetic core 160 is supported by a mandrel 920 having a central shaft 922 that is selectably rotatable in a direction 924, as indicated by an arrow. System 910 includes a creel 930 that supports a plurality of spools 934 of fiber. The fiber can be of any suitable nonmagnetic type including but not limited to nomex, nylon, aramix and fiberglass. Rovings 940 are drawn as bundles of fibers from a group of spools of the creel. The rovings enter separator combs 944 which serve to space apart and tension the fibers for immersion in a resin bath 946 passing under rollers 948 to saturate the fibers with a resin. The resin can be any suitable type such as, for example, G10/G11 Epoxy, polyester and the like. The saturated fibers then pass between a par of nip rollers 949 which compress the roves and remove excess resin. The roves are then pulled through a guide 950 responsive to rotation of ductile magnetic core 160 by mandrel 920 while the guide gathers the roves and is moved laterally back and forth laterally in a manner that is indicated by arrows 954 to apply the roves in a cross-hatched manner, as illustrated. This process continues until the wrapped structure reaches a desired thickness such as, for example, in a range from 0.08 inch to 0.1 inch. Accordingly, a wet wrap filament wound outer main body tube 958 is produced that encapsulates ductile magnetic core 160 including the flexible permeable magnetic sheet material and antenna winding 150 thereby providing a remarkably robust yet thin main body tube or outer shell upon curing.

In view of the embodiments of a transmitter produced in accordance with the teachings above, it is submitted that the ductile magnetic core brought to light herein as well as associated features allows for a new generation of horizontal directional drilling transmitters with heretofore unseen physical and performance attributes. With respect to physical attributes, some transmitter embodiments provide for installation in a standard transmitter housing while still accommodating the use of standard diameter batteries. Additionally, empirical testing of a transmitter produced in accordance with the teachings brought to light above to include encapsulated intermediate core 300 of FIG. 10 revealed a remarkable degree of resistance to mechanical shock and vibration, for example, satisfying the requirements under the Mil-Std-810H Sinusoidal and Random Vibration Test. Additionally, a three point bend test was performed in which a force was applied to the side of the subject transmitter. With the transmitter ends fixedly supported, the transmitter was subjected to bending intended to mimic bending induced by bending of drill housing 30 of FIG. 1 during inground operation. The subject transmitter exhibited no operational degradation in performance up to 0.5 inch of deflection. Applicant submits that this is a result that represents a sweeping improvement over the state-of-the-art and is heretofore unseen.

With respect to performance attributes, the magnetic properties of the disclosed magnetic core are submitted to rival that of far larger magnetic cores of the prior art, thereby enabling a ductile magnetic core with a sidewall thickness that contributes almost negligibly to the overall diameter of the transmitter. For example, the sidewall thickness of electromagnetically permeable ductile magnetic core 160 can be on the order of 0.02 inch. At the same time, locating signal transmission efficiency is enhanced due to the use of an essentially full length antenna which can provide a relative increase in battery life and/or the ability to transmit a locating signal at a higher signal strength than would otherwise be possible.

The foregoing description of the invention has been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

1. A transmitter, comprising:
an elongated inner tube defining at least a portion of an electronics region for receiving an electronics module and a battery region for receiving at least one battery;
an electromagnetically permeable ductile core surrounding the elongated inner tube formed from a flexible core material;
an antenna coil wound around the flexible electromagnetically permeable ductile core to surround at least one portion of the electronics region and another portion of the battery region; and
an elongated outer tube serving as an outer structural member of the transmitter that is sealable at first and second opposing ends.

2. The transmitter of claim 1 wherein the elongated inner tube, the electromagnetically permeable ductile core and the antenna coil are encapsulated for receiving the elongated outer tube.

3. The transmitter of claim 1 wherein the antenna coil and the electromagnetically permeable ductile core are encapsulated between the elongated outer tube and the elongated inner tube such that the outer tube is bonded to the antenna coil and the electromagnetically permeable ductile core as part of an integral unit.

4. The transmitter of claim 1 wherein the electromagnetically permeable ductile core is formed from a flexible electromagnetically permeable sheet material.

5. The transmitter of claim 4 wherein the flexible electromagnetically permeable sheet material includes a thickness in a range from 0.001 inch to 0.005 inch.

6. The transmitter of claim 4 wherein the flexible electromagnetically permeable sheet material is wrapped around the elongated inner tube.

7. The transmitter of claim 6 wherein the flexible electromagnetically permeable flexible sheet material is wrapped to form a plurality of overlapping layers.

8. The transmitter of claim 4 wherein the flexible electromagnetically permeable sheet material is spiral wound around the elongated inner tube.

9. The transmitter of claim 4 wherein the electromagnetically permeable ductile core is formed from one or more individual sheets of the electromagnetically permeable sheet material.

10. The transmitter of claim 9 wherein the one or more individual sheets are wrapped sequentially around the elongated inner tube.

11. The transmitter of claim 9 wherein at least one individual sheet of the flexible electromagnetically permeable sheet material includes a length to form more than one complete wrap around the elongated inner tube and any underlying wraps of the electromagnetically permeable sheet material.

12. The transmitter of claim 11 wherein the electromagnetically permeable ductile core is formed from a metal alloy including silicon and iron.

13. The transmitter of claim 9 wherein each individual sheet of the flexible electromagnetically permeable sheet material includes opposing widthwise edges and at least one of the individual sheets is spiral wrapped to form an electrically isolating gap with a confronting widthwise edge of a successive one of the individual sheets in the spiral wrap.

14. The transmitter of claim 9 wherein at least one individual sheet of the flexible electromagnetically permeable sheet material includes opposing widthwise edges that are placed in a confronting relationship by the complete wrap around the elongated inner tube and any underlying layers.

15. The transmitter of claim 4 wherein the flexible electromagnetically permeable sheet material defines at least one elongated slot through a thickness thereof.

16. The transmitter of claim 4 wherein at least a portion of the flexible electromagnetically permeable sheet material defines a plurality of elongated slots through a thickness thereof.

17. The transmitter of claim 16 wherein an elongated dimension of the slots is aligned with an elongation axis of the elongated inner tube.

18. The transmitter of claim 16 wherein the flexible electromagnetically permeable sheet material includes a grain orientation and an elongated dimension of the slots is aligned with the grain orientation.

19. The transmitter of claim 4 wherein the electromagnetically permeable ductile core is formed from a single continuous sheet of the electromagnetically permeable sheet material.

20. The transmitter of claim 4 wherein at least one major surface of the electromagnetically permeable sheet material supports an electrical insulating layer.

21. The transmitter of claim 20 wherein the electrical insulating layer is a flexible ceramic material.

22. The transmitter of claim 4 wherein the flexible electromagnetically permeable sheet material includes a grain orientation and the grain orientation is aligned with an elongation dimension of the elongated inner tube.

23. The transmitter of claim 4 wherein the flexible electromagnetically permeable sheet material is provided as a plurality of individual sheets such that the individual sheets are wrapped in sequence around the elongated inner tube.

24. The transmitter of claim 1 wherein the electromagnetically permeable ductile core is formed from a metal alloy.

25. The transmitter of claim 24 wherein the metal alloy includes silicon and iron.

26. The transmitter of claim 1 wherein the elongated outer tube is bonded to the electromagnetically permeable ductile core, the antenna coil and the elongated inner tube by a bonding agent that is injected at least into an annular gap between an outer surface of the elongated inner tube and an inner surface of the elongated outer tube.

27. The transmitter of claim 26 wherein the bonding agent is an epoxy.

28. The transmitter of claim 1 wherein the elongated outer support tube is a preformed fiber reinforced plastic material.

29. The transmitter of claim 1 wherein the elongated outer support tube is a fiber reinforced plastic that is wet wrapped onto the flexible electromagnetically permeable sheet material, the antenna coil and at least opposing end portions of the elongated inner tube.

30. The transmitter of claim 1 wherein the elongated inner tube, the electromagnetically permeable ductile core and the elongated outer tube cooperate to form an overall transmitter body having a sidewall thickness that is no more than ⅛ inch with said antenna coil encapsulated therein.

31. The transmitter of claim 1 including an outer diameter configured to be receivable in an HDD industry-standard transmitter housing.

32. The transmitter of claim 31 wherein the outer diameter transmitter is 1.25 inches.

33. The transmitter of claim 1, further comprising:
a first end cap and a second end cap for sealing the first and second opposing ends, respectively, of the elongated outer tube, the first end cap including an annular skirt that defines a window outward of the electromagnetically permeable ductile core with the first end cap installed on the first end of the transmitter for external radio frequency communication with the electronics module through the window.

34. The transmitter of claim 33 further comprising:
an end portion of the electronics module including a transceiver having an integral radio frequency antenna and the end portion of the electronics module is received within the annular skirt with the first end cap installed on the first end of the transmitter such that the integral radio frequency antenna is in a confronting relationship with the window.

35. The transmitter of claim 34 wherein the electronics module includes an infrared port positioned adjacent to the radio frequency antenna and in electrical communication with the transceiver for external optical communication through the window.

36. The transmitter of claim 1 further comprising:
a first end cap and second end cap for sealing the first and second opposing ends, respectively, of the elongated inner support tube, the first end cap including an annular peripheral configuration defining an antenna recess for receiving a radio frequency antenna to position the radio frequency antenna outward of the electromagnetically permeable core with the first end cap installed on the first end of the transmitter and the electronics module includes a transceiver in electrical communication with the radio frequency antenna via at least one electrical conductor.

37. A transmitter, comprising:
an elongated housing defining an interior cavity including an electronics region receiving an electronics module and a battery compartment;
a battery pack receivable in the battery compartment for powering the electronics module; and
a battery end cap extractor that is removably receivable on an end of the elongated housing proximate to the battery compartment configured to cooperate with the battery pack, when received in the battery compartment, such that removing the end cap assembly extracts the battery pack from the battery compartment.

38. The transmitter of claim 37 wherein the battery end cap extractor is configured to apply at least 0.5 pounds of force to extract the battery.

39. The transmitter of claim 38 wherein an outward end of the battery pack confronting the battery end cap extractor is recessed in the elongated housing when the battery pack is installed therein.

40. An end cap for a transmitter having an elongated transmitter body with an end opening for receiving the end cap and having an outer diameter, said end cap comprising:
a main body defining an interior cavity, said main body including:
an inward end configured as a tubular sleeve for sealed engagement with the elongated transmitter body and for surrounding a portion of the interior cavity; and
a peripheral sidewall configuration surrounding the interior cavity between the inward end and the outward end, the peripheral sidewall configuration defining an inset floor for supporting a radio frequency antenna and said inset floor including a feedthrough leading to the interior cavity for routing an electrical conductor therethrough to electrically connect the radio frequency antenna to a radio frequency transceiver that forms part of an electronics module housed within the transmitter for external radio frequency communication.

41. The end cap of claim 40 further comprising:
an outward end of the main body defining a pressure port at an outer end of the interior cavity for receiving a pressure sensor to expose a pressure membrane of the pressure sensor to an ambient pressure surrounding the transmitter.

42. The end cap of claim 40 wherein the radio frequency transceiver is a Bluetooth™M transceiver.

43. The end cap of claim 40 further comprising:
a sealed optical port formed in the peripheral sidewall configuration for external optical communication with an optical transceiver forming another part of the electronics module.

44. The end cap of claim 43 wherein the optical transceiver is an infrared transceiver.

45. A transmitter, comprising:
an elongated tubular transmitter body serving to define an electronics region for receiving an electronics module and a battery region for receiving a battery pack such that the elongated transmitter body is sealable by a first end cap and an opposing, second end cap;
the first end cap including a main body that defines an interior cavity, the main body including:
an inward end configured as a tubular sleeve for sealed engagement with the elongated transmitter body and surrounding a portion of the interior cavity; and
a peripheral sidewall configuration surrounding the interior cavity between the inward end and the outward end, the peripheral sidewall configuration defining an inset floor for supporting a radio frequency antenna and said inset floor including a feedthrough leading to the interior cavity for routing an electrical conductor therethrough to electrically connect the radio frequency antenna to a radio frequency transceiver that forms one part of an electronics module for external radio frequency communication.

46. The transmitter of claim 45 further comprising:
an outward end of the main body defining a pressure port at an outer end of the interior cavity for receiving a pressure sensor to expose a pressure membrane of the pressure sensor to an ambient pressure surrounding the transmitter.

47. A transmitter, comprising:
an elongated tubular transmitter body serving to define an electronics region for receiving an electronics module including an end portion that supports a radio frequency transceiver having an antenna and a battery region for receiving a battery pack such that the elongated transmitter body is sealable by a first end cap and an opposing, second end cap;
the first end cap including a main body that defines an interior cavity, the main body including:
an inward end configured as a tubular sleeve for sealed engagement with the elongated transmitter body and surrounding a portion of the interior cavity; and
a peripheral sidewall configuration surrounding the interior cavity between the inward end and the outward end such that the end portion of the electronics module is received in the interior cavity to place the antenna of the radio frequency transmitter in a confronting relationship with a sealed window that is defined by the peripheral sidewall configuration for external radio frequency communication through said window.

48. The transmitter of claim 47 further comprising:
an outward end of the main body defining a pressure port at an outer end of the interior cavity for receiving a pressure sensor to expose a pressure membrane of the pressure sensor to an ambient pressure surrounding the transmitter.

49. The end cap of claim 47 wherein the electronics module includes an optical transceiver including an optical detector/transmitter pair that are positioned in another confronting relationship with said window for external optical communication therethrough.

50. The end cap of claim 49 wherein the optical transceiver is an infrared transceiver.

51. An end cap for a transmitter used in an inground operation, the transmitter having a transmitter body that defines an opening leading to a transmitter interior cavity which is configured to receive an electronics package and at least one battery, said end cap comprising:
an end cap body including (i) an annular inner end configured for removably sealingly engaging the opening of the transmitter body such that the battery is removably installable in the transmitter interior cavity with the end cap removed from the transmitter body and (ii) an outer closed end, opposite the annular inner end, that defines an aperture for use in equalizing pressure in the transmitter interior cavity with an ambient environment; and
a thermal safety plug sealingly received in said aperture having a predetermined failure temperature such that the transmitter interior cavity is pressure isolated from the ambient environment during operation of the transmitter which subjects the thermal safety plug to temperatures below the predetermined failure temperature and, above the predetermined failure temperature, the thermal safety plug releases an internal pressure of the transmitter interior cavity to the ambient environment.

52. The end cap of claim 51 wherein the predetermined failure temperature is based on subjecting the thermal safety plug to a thermal runaway of the battery.

53. The end cap of claim 51 wherein the predetermined failure temperature is a melting temperature.

54. The end cap of claim 51 formed from nylon.

55. The end cap of claim 51 wherein the thermal safety plug is threadingly received in the aperture.

56. The end cap of claim 51 wherein the thermal safety plug is received in the aperture by a press fit.

57. The end cap of claim 51 further comprising a center tubular post leading from the outer end, through the annular inner end and extending inward beyond the annular inner end to a distal inner end such that the center tubular post defines said aperture.

58. The end cap of claim 57 wherein the aforerecited at least one battery forms part of a battery pack and a battery extractor spacer is receivable on the distal inner end of the center tubular post and the battery extractor spacer is configured to cooperate with the battery pack, when received in the battery compartment, such that removing the end cap extracts the battery pack from the battery compartment.

59. An apparatus for wrapping a flexible permeable magnetic sheet material onto a core tube to form a magnetic core, said apparatus, comprising:
a first roller and a second roller supported for free rotation about a first elongation axis and second elongation axis, respectively, and in a spaced apart, parallel relationship; and
a driven roller supported for selective rotation about a drive roller elongation axis, the driven roller selectively movable between an engaged position and a disengaged position such that, in the engaged position, the core tube is captured between the drive roller, the first roller and the second roller and, responsive to rotation of the driven roller, at least the flexible permeable magnetic sheet material (i) enters between the first roller and the core tube, (ii) is carried by the core tube for compression between the second roller and the core tube and (iii) is carried by the core tube for further compression between the driven roller and the core tube to wrap the flexible permeable magnetic sheet material around the core tube and onto one or more underlying layers of the flexible permeable magnetic sheet material and, in the disengaged position, the core tube and the flexible permeable sheet material wrapped therearound are removable from the apparatus.

60. The apparatus of claim 59 wherein the first roller, the second roller and the driven roller are of an equal diameter.

61. The apparatus of claim 60 wherein the first roller, the second roller and the driven roller are configured with at least an elastic surface for gripping the flexible permeable magnetic sheet material.

62. The apparatus of claim 60 wherein an isosceles triangle is defined in an end view by the first elongation axis of the first roller, the second elongation axis of the second roller and the drive roller axis of the driven roller such that drive roller axis is at an apex of the isosceles triangle with equal length sides extending to the first elongation axis and to the second elongation axis.

63. The apparatus of claim 59 configured for receiving a carrier sheet which supports and carries the flexible permeable magnetic sheet material to (a) enter between the first roller and the core tube, (b) carry the flexible permeable magnetic sheet material for compression between the second roller and the core tube and (c) separate from the flexible permeable magnetic sheet material after passing between the driven roller and the core tube such that the carrier sheet then passes around a portion of the periphery of the driven roller to exit the apparatus.

64. A method for wrapping a flexible permeable magnetic sheet material onto a core tube to form a magnetic core, said method comprising:
capturing the core tube between a first roller, a second roller and a driven roller such that rotation of the driven roller rotates the core tube and the core tube, in turn, rotates the first roller and the second roller;
supporting the flexible permeable magnetic sheet material on a carrier sheet; and
feeding the carrier sheet and the flexible permeable magnetic sheet material between the first roller and the core tube while driving the driven roller such that (i) the carrier sheet and the flexible permeable magnetic sheet material are compressed between the core tube and the first roller, (ii) the carrier sheet and the flexible permeable magnetic sheet material are then carried by the core tube for further compression between the second roller and the core tube and, thereafter, (iii) carried by the core tube for additional compression between the driven roller and the core tube to continue to wrap the flexible permeable magnetic sheet material around the core tube and onto one or more underlying layers of the flexible permeable magnetic sheet material as the carrier sheet separates from the flexible permeable magnetic sheet material after passing between the driven roller and the core tube such that the carrier sheet, thereafter, passes around a portion of the periphery of the driven roller to depart.
